(19) United States
(12) Patent Application Publication
(10) Pub. No.: US 2025/0238547 A1
(43) Pub. Date: Jul. 24, 2025

(54) SYSTEM AND METHOD FOR GENERATING DYNAMICALLY VARIABLE MULTI-DIMENSIONAL DATA SECURITY AND PRIVACY RATINGS FOR VEHICLES

(71) Applicant: Privacy4Cars, Inc., Kennesaw, GA (US)

(72) Inventor: Andrea Amico, Kennesaw, GA (US)

(21) Appl. No.: 19/173,514

(22) Filed: Apr. 8, 2025

Related U.S. Application Data
(63) Continuation-in-part of application No. 18/399,956, filed on Dec. 29, 2023, now Pat. No. 12,287,904.
Application No. 18/399,956 is a continuation of application No. 17/350,698, filed on Jun. 17, 2021, now Pat. No. 11,921,886.

(51) Int. Cl. G06F 21/62; G06F 18/2113; G06F 18/214; G06N 3/08

(52) U.S. Cl. CPC G06F 21/6245; G06F 18/2113; G06F 18/214; G06N 3/08

(57) ABSTRACT

A data security method includes generating, using artificial intelligence algorithms, at least one machine learning model that is configured to generate scores for multiple attributes of one or more data handling approaches associated with a vehicle and/or an in-vehicle unit. The method further includes analyzing one or more data handling approaches associated with a target vehicle or a target in-vehicle unit. The method further includes generating, using the at least one machine learning model and the one or more data handling approaches that have been analyzed, scores for the multiple attributes of each of the one or more data handling approaches. The method includes processing the scores to generate a data handling score for one or both of the target vehicle or in-vehicle unit. The data handling score includes a security score for one or both of the target vehicle or the in-vehicle unit.

### CROSS-REFERENCE TO RELATED APPLICATIONS

This application is a continuation-in-part of U.S. application Ser. No. 18/399,956, filed Dec. 29, 2023, which is a continuation of U.S. patent application Ser. No. 17/350,698, filed Jun. 17, 2021, the entirety of which is fully incorporated herein by reference

### TECHNICAL FIELD

Embodiments of the present disclosure relate to connected devices, and particularly to systems and methods to generate dynamically variable multi-dimensional scores (including security and/or privacy scores) for vehicles and/or associated in-vehicle units.

### BACKGROUND

Over the past two decades, the automotive industry has witnessed huge transformation and advancement of technology to enhance the in-vehicle experience of a user. While such advancements provide enormous safety, convenience, and other important benefits that enhance the in-vehicle experience of the user, very little is being done to protect data that is either generated by and/or used by the vehicles in the process of enhancing the in-car experience. Such data is confidential, personal and/or otherwise associated with a user of the vehicle; users today are increasingly concerned with the security and privacy of their data. Users want to ensure that persons and entities that access such data are only those allowed to see; that is, users desire data security. Users also want to have control over, protect, and maintain privacy of such personal data to avoid privacy threats such as identity theft, including controlling what data the user provides; that is, users also desire data privacy.

Conventional approaches in the automative industry to data security for vehicles are lacking. Often a user of a connected vehicle and/or associated in-vehicle unit has little to no control over key aspects of data security. For example, a user may have no practical way to determine whether the vehicle or associated in-vehicle unit is susceptible to faulty data handling practices, such as, without limitation, practices related to encryption, data retention, authentication, transmission protocol, API and/or software bill of materials. Further, a user may have no practical way to determine whether the vehicle or associated in-vehicle unit is susceptible to known bugs and vulnerabilities, such as, without limitation, published bugs or security holes, including indications of vulnerabilities, as may be found in certain KEV Catalogs or CVE Notices. Further, a user may have no practical way to determine whether the vehicle or associated in-vehicle unit is susceptible to hacks or other problems present in certain news and information channels, such as, without limitation, online business news, social media news, and dark web news. Any of the foregoing sources of digital web content may present information indicative of faulty security practices. Conventional approaches in the art not only fail to provide a user a manner in which to determine said information, conventional approaches also fail to synthesize the foregoing digital web content in a manner that allows the user to make real time security conscience decisions based on a dynamically updated machine learning model. Accordingly, conventional approaches to security management present significant drawbacks that hinder the ability of the user to secure personal data.

Additionally, conventional rating technologies in the automative industry are also lacking for vehicles. For example, conventional rating technologies used in association with apps and/or websites are one-dimensional because the interactions of users with such apps and/or websites are highly standardized. That is, data handling is the same across different apps and/or websites. But data handling for vehicles is multi-dimensional; and more diverse, complex, and non-standardized compared to websites and apps. Further, vehicles have multiple approaches associated therewith that govern the data handling. For example, in addition to data handling approaches associated with the manufacturer of the vehicle, each in-vehicle device and services that handle the personal data of the user may have their own data handling approaches that are different from each other and that of the manufacturer. Often, the different data handling approaches are highly non-transparent to the user. Also, conventional rating technologies fail to meaningfully engage the manufacturers and/or the entities that handle personal data of the user in a vehicle to improve their data handling approaches. There is a need in the art to address these deficiencies, both as concern security and privacy, in the automotive industry.

This background information is provided to reveal information believed to be of possible relevance to the present disclosure. No admission is necessarily intended, nor should be construed, that any of the preceding information constitutes prior art against the present disclosure.

### SUMMARY

In one example, a method is disclosed. The includes generating, using artificial intelligence algorithms and a training dataset, at least one machine learning model that is configured to generate scores for multiple attributes of one or more data handling approaches associated with a vehicle and/or an in-vehicle unit of the vehicle that handles data of a user. The training dataset includes a plurality of labelled documents that define the one or more data handling approaches associated with the vehicles and/or the in-vehicle unit. Each labelled document has scores pre-assigned to one or more of the multiple attributes of the respective data handling approach associated therewith. The method further includes receiving identification information. The method further includes determining one or more data handling approaches of a target vehicle and/or a target in-vehicle unit, in either case, which are associated with the identification information and that handles data of the user. The method further includes analyzing the one or more data handling approaches associated with the target vehicle or the target in-vehicle unit. The method further includes generating, using the at least one machine learning model and the one or more data handling approaches that have been analyzed, scores for the multiple attributes of each of the one or more data handling approaches. The method includes processing the scores to generate a data handling score for one or both of the target vehicle or in-vehicle unit.

In another example, the data handling score may include a security score for one or both of the target vehicle or the in-vehicle unit.

In another example, the security score may include an indication of whether the data of the user is viewed or accessed by authorized individuals.

In another example, the determining of the one or more data handling approaches may further include identifying digital web content associated with the target vehicle or the target in-vehicle unit. The digital web content may include at least one of, with respect to the target vehicle or the target in-vehicle unit, data handling practices, known vulnerabilities, or online news. The determining of the one or more data handling approaches may further include analyzing the digital web content to determine one or more data handling attributes associated with the digital web content. The determining of the one or more data handling approaches may further include determining the data handling approach based on the determined one or more data handling attributes of the analyzed web content.

In another example, the method may further include identifying digital web content using one or both of a third-party database or a web crawler.

In another example, the identifying of the digital web content may further include identifying the digital web content by scraping open APIs.

In another example, the digital content may include data handling practices associated with either the target vehicle or the target in-vehicle unit. In this regard, the method may further include analyzing a content of said data handling practices to determine a plurality of practice topics and associated provisions. The method may further include comparing said determined provisions to one or more baseline provisions associated with a respective practice topics. The method may further include determining said one or more data handling attributes based on an indication of a deviation of said compared provisions from said one or more standard provisions. The method may further include updating the data handling approach based on said indication.

In another example, the data handling practices may include one or more practice topics associated with, in each case for the respective targe vehicle or the target in-vehicle unit, an encryption topic, a data retention topic, an authentication topic, a known transmission protocol topic, an API topic, or a software bill of materials topic.

In another example, the digital web content may include known vulnerabilities. In this regard, the method may further comprises identifying a software bill of materials. The method may further comprise comparing the known vulnerabilities to the software bill of materials. The method may further include determining said one or more data handling attributes based on an indication of a presence of said known vulnerability in the software bill of materials. The method may further include updating the data handling approach indicative of software vulnerabilities of contained within software bill of materials.

In another example, the known vulnerabilities may include published bugs or security holes in open source software components.

In another example, the known vulnerabilities may be extracted from KEV Catalog or CVE Notices.

In another example, the digital content may include online news associated with the respective target vehicle or the target in-vehicle unit. The online news may include at least one of online business news, social media news, or dark web news. In this regard, the method may further include, for each such digital content, analyzing a content of said online news to determine a plurality of topical entries and associated topical data. The method may further include, comparing said determined topical data to one or more baseline conditions associated with a respective topical entry. The method may further include determining said one or more data handling attributes based on an indication of a deviation of said determined topical data from said one or more baseline condition. The method may further include updating the data handling approach indicative of deviations in the online news from a baseline.

In another example, the topical entries may include a breach notification, a regulatory action, a white-hat disclosure, a black-hat announcement, an indication of data for sale, an indication of hacks for sale.

In another example, the online news may include at least two of the online business news, social media news, or dark web news. In this regard, the method may further include a relative reliability of the at least two of the online business news, social media news, or dark web news. Further, the updating of the data handling approach further comprises influencing the data handling approach to a greater extent based on the online news having a greater relative reliability as compared to the online news having a lesser relative reliability.

In another example, the method may include creating or supplementing the plurality of labelled documents for the generating of the at least one machine learning model by storing labelled documents indicative of the determined data handling approach.

In another example, a method is disclosed. The includes generating, using artificial intelligence algorithms and a training dataset, at least one machine learning model that is configured to generate a data handling score associated with a vehicle and/or an in-vehicle unit of the vehicle that handles personal data of a user. The training dataset includes a plurality of labelled documents that define one or more data handling approaches associated with the vehicles and/or the in-vehicle unit. Each labelled document has scores pre-assigned to the respective data handling approach associated therewith. The method further includes receiving identification information. The method further includes determining one or more data handling approaches of a target vehicle and/or a target in-vehicle unit, in either case, which are associated with the identification information and that handles data of the user. The determining includes, identifying digital web content associated with the target vehicle or the target in-vehicle unit. The digital web content includes at least one of, with respect to the target vehicle or the target in-vehicle unit, data handling practices, known vulnerabilities, or online news. The method further includes analyzing the one or more data handling approaches associated with the target vehicle and the at least one in-vehicle unit of the target vehicle. The method further includes generating, using the at least one machine learning model and the one or more data handling approaches that have been analyzed, a data handling score for the target vehicle or the target in-vehicle unit. The method further includes dynamically adjusting the data handling score for one or both of the target vehicle or the in-vehicle unit based on data handling change factors.

In another example, the artificial intelligence algorithms may include natural language processing algorithms and machine learning algorithms.

In another example, the one or more data handling approaches may be analyzed using natural language processing algorithms that are configured to generate feature vectors from the one or more data handling approaches.

In another example, the data handling change factors may include at least one of a usage status of the target in-vehicle unit or data handling practices of entities associated with the target vehicle and/or the target in-vehicle unit that handle the data of the user.

In another example, a method is disclosed. The method includes generating, using artificial intelligence algorithms and a training dataset, at least one machine learning model that is configured to generate scores for multiple attributes of one or more data handling approaches associated with a vehicle and/or a service provider associated with the vehicle that handles data of a user. The training dataset may include a plurality of labelled documents that define the one or more data handling approaches associated with the vehicles and/or the service provider. Each labelled document has scores pre-assigned to one or more of the multiple attributes of the respective data handling approach associated therewith. The method further includes receiving identification information. The method further includes determining one or more data handling approaches associated with a target vehicle linked to the identification information and at least one service provider of the target vehicle that handles data of the user. The one or more data handling approaches is based, at least in part, on, with respect to the target vehicle and/or the service provider of the target vehicle, data handling policies, known vulnerabilities, or online news. The method further includes analyzing the one or more data handling approaches associated with the target vehicle and/or the at least one service provider of the target vehicle. The method further includes generating, using the at least one machine learning model and the one or more data handling approaches that have been analyzed, scores for the multiple attributes of each of the one or more data handling approaches. The method further includes processing the scores to generate a data handling score one or both of the target vehicle or the service provider of the target vehicle.

In addition to the example aspects described above, further aspects and examples will become apparent by reference to the drawings and by study of the following description.

### BRIEF DESCRIPTION OF THE DRAWINGS

The foregoing and other features and aspects of the present disclosure are best understood with reference to the following description of certain example embodiments, when read in conjunction with the accompanying drawings, wherein:

FIG. 1A illustrates an example operating environment of a data handling score generation system, in accordance with example embodiments of the present disclosure;

FIG. 1B illustrates an example network schematic including digital web content used in the determination of data handling approaches;

FIG. 2A illustrates an example block diagram of a server of the data handling score generation system shown in FIG. 1A, in accordance with example embodiments of the present disclosure;

FIG. 2B illustrates an example block diagram of another server of the data handling score generation system shown in FIG. 1A, in accordance with example embodiments of the present disclosure;

FIG. 3A illustrates an example block diagram of a user computing device of the data handling score generation system shown in FIG. 1A, in accordance with example embodiments of the present disclosure;

FIG. 3B illustrates an example block diagram of another user computing device of the data handling score generation system shown in FIG. 1A, in accordance with example embodiments of the present disclosure;

FIGS. 4A-4C (collectively “FIG. 4”) illustrate an example operation of the data handling score generation system shown in FIG. 1A, in accordance with example embodiments of the present disclosure;

FIG. 5 illustrates an example machine learning model generation operation of the data handling score generation system, in accordance with example embodiments of the present disclosure;

FIG. 6 illustrates an example data acquisition operation of the server to determine the vehicle, the in-vehicle units of the vehicle, and entities associated with both the vehicle and the in-vehicle units that handle personal data of a user, in accordance with example embodiments of the present disclosure;

FIG. 7 illustrates an example web content data acquisition operation of the server to determine a data handling approach one or both of the target vehicle or the in-vehicle unit;

FIG. 8 illustrates an example operation of the server to update a data handling approach based on data handling practices web content;

FIG. 9 illustrates an example operation of the server to update a data handling approach based on known vulnerabilities web content; and

FIG. 10 illustrates an example operation of the server to update a data handling approach based on online news web content.

The drawings illustrate only example embodiments of the present disclosure and are therefore not to be considered limiting of its scope, as the present disclosure may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles.

### DETAILED DESCRIPTION

The present disclosure describes a method, apparatus, and/or system that provides a technical solution rooted in computer technology—machine learning and natural language processing—to address one or more technical problems of data security risks and data privacy risks in vehicles. Such technical problems include, but are not limited to, the lack of existing technology that provides a platform for users to determine security and privacy risks associated with a vehicle; the inability of existing one-dimensional and static security and privacy scoring technologies used in other sectors to effectively capture the complexity involved with data security in vehicles; etc. Further, the method, apparatus, and system of the present disclosure is configured to provide practical applications of, inter alia, (a) making security and privacy transparent and visible to a user by providing a platform to easily and accurately obtain an assessment of security and privacy risks related to the personal data of the user in association with a vehicle and/or in-vehicle unit without having to investigate potentially thousands of disparate (and potentially non-existent) sources of security related content and/or without having to read and comprehend thousands of pages of privacy policies, (b) providing a breakdown of the security and/or privacy risk assessment of each in-vehicle units that handles personal data of the user, (c) providing options to users to take control of their data when interacting with a vehicle and/or in-vehicle unit, etc.

In the following paragraphs, a system, method, and apparatus for obtaining a multi-dimensional and dynamically variable “data handling score” (also referred to herein generally as a “rating” or “score”) for a vehicle and/or associated in-vehicle unit using artificial intelligence (hereinafter “vehicle data system”) will be described in further detail by way of examples with reference to the attached drawings. As described herein below, the data handling score or rating may encompass security considerations and/or privacy considerations of a respective target vehicle and/or in-vehicle unit, as may be appropriate for a given application. Broadly, and as described further herein, “security” refers to data considerations in reference to ensuring that the persons and entities that have access to a user's data are indeed authorized to do so, whereas “privacy” refers to data considerations in reference to controlling what data of the user said persons and entities have access to at all (and for what duration, and for what purposes, and so on). In this regard, data security and data privacy may include complementary, and potentially overlapping considerations; and as such, the terms data security and data privacy, as used here, are not necessarily mutually exclusive. In the description, well known components, methods, and/or processing techniques are omitted or are briefly described so as not to obscure the disclosure. As used herein, the “present disclosure” refers to any one of the embodiments of the disclosure described herein and any equivalents. Furthermore, reference to various feature(s) of the “present disclosure” is not to suggest that all embodiments must include the referenced feature(s).

In one example, a vehicle data system (“system”) of the present disclosure determines a vehicle and/or in-vehicle units of the vehicle that handle data of a user, such as personal data and/or any other data associated with, concerning or of interest to the user. Further, the system determines entities associated with the vehicle and/or the in-vehicle units that handle the data of the user. Then, the system determines and retrieves data handling approaches of each entity. Responsive to retrieving the data handling approaches, the system uses natural language processing and machine learning to analyze the retrieved data handling approaches and rate at least one attribute associated with each data handling approach. The system assigns weights to the various attributes of each data handling approach. The weights may be assigned based on at least one of user preferences and various security, privacy and/or other elements associated with the vehicle and/or the in-vehicle units. The system combines the weights and the ratings of the attributes of each data handling approach. Then, the weighted ratings of each data handling approach are used to generate a data handling score or rating (including, a security and/or privacy rating) for the vehicle and/or respective in-vehicle unit. Further, the system is configured to dynamically adjust the rating of the vehicle (or in-vehicle unit) based on various change factors such as, but not limited to, usage status of the various in-vehicle units, data handling practices of the entities associated with the vehicle and/or the in-vehicle units that handle the data of the user, etc. It is noted that the rating may be published in a number of places including, but not limited to, online platforms, at dealerships, at rental vehicle centers, on the vehicle stickers, etc., as appropriate. In other cases, the rating is shared with the user alone.

Before discussing the examples directed to the vehicle data system of the present disclosure, it may assist the reader to understand the various terms used herein by way of a general description of the terms in the following paragraphs.

The term “in-vehicle unit” may generally refer to any hardware device and/or software module that is integrated with, embedded in, or attached to a vehicle; and that handles data of a user. The in-vehicle units may include modules or devices that are included in the vehicle from the factory and/or aftermarket modules or devices attached to the vehicle. Examples of in-vehicle units of a vehicle may include, but is not limited to, infotainment units, navigational units, Bluetooth units, garage door opener units, driver safety units, safe driving assistance units, telematics units, etc.

The term “handle” or “handling” as used herein in the context of data may generally refer to any appropriate interaction with the data of a user in a way that may affect the security and/or privacy of the personal data. Examples of handling data may include, but are not limited to, receiving, retaining, sharing, transmitting, using, selling, controlling, etc.

The term “data handling approaches” may generally refer to any appropriate information that discloses/defines procedures, practices, or rules associated with handling data of a user, including the handling of security aspects and/or privacy aspects of said data. Said information may include, but is not limited to, a security and/or privacy policies, Terms of Services (ToS), other documented privacy practices, etc. For example, without limitation, data handling approaches may be informed fully or in part by certain encryption practices, data retention practices, authentication practices, transmission protocols, API and/or software bills of materials, any of which may be considered “digital web content”, as described herein. As another example, without limitation, data handling approaches may be informed fully or in part by certain known vulnerabilities including published bugs and security holes, any of which may be considered digital web content, as described herein. As another example, without limitation, data handling approaches may be informed fully or in part by certain type of inline news, including online business news, social media news, and/or dark web news, any of which may be considered digital web content, as described herein. Further, said information may include data that is not available in privacy policies, ToS, and/or documented privacy practices and features such as, but not limited to, information regarding features associated with an in-vehicle unit or the vehicle that allow a user to opt in or opt out of the user's personal data being handled, features that indicate to a user that an in-vehicle unit is collecting data, interactive features that allow user to take control of the user's personal data, documents that inform the user of such features related to privacy, etc. For example, a visual cue such as an icon that indicates to a user that personal data is being collected and shared; graphical control elements such as check boxes or radio buttons that a user can interact with to opt out of personal data being used; etc. Such information that is not available in privacy policies or ToS's may be ascertained by manual inspection of and/or interaction with the vehicle and in-vehicle devices. Additionally, such information may be received from crowd source platforms, manufacturers, third parties, etc.

It is noted that, the term “data handling approaches associated with a vehicle and/or in-vehicle unit” may refer to data handling approaches of any appropriate entities associated with the vehicle and/or in-vehicle unit that handle data of the user. For example, if the vehicle associated with the user is a Mazda Miata; the data handling approaches associated with Mazda Miata may refer to and include, but are not limited to, the security-related and/or privacy policies of Mazda Motors in general, the security-related and/or privacy policies of Mazda Motors specific to Miata model, the security-related and/or privacy policies of Bose infotainment system in the Mazda Miata, security-related and/or privacy policies associated with Sirius XM service provider, security-related and/or privacy policies associated with Progressive insurance if a Progressive telematics device is installed or if Progressive insurance covers the Mazda Miata vehicle associated with the user, security-related and/or privacy policies associated with the specific Mazda dealership where the vehicle is serviced, security-related and/or privacy policies of the dealership/agency from where the vehicle was purchased or rented (if rental vehicle), etc.

The term “attributes” as used herein in association with data handling approaches may include, but is not limited to, accessibility, availability, breadth/extent, complexity, etc., of the data handling approaches. Further, the term “attributes” may include various data security and privacy aspects such as, but not limited to, data collection, protection of children, third party sharing, data security, data retention, data aggregation, control of data, privacy settings, account deletion, privacy breach notifications, policy changes, country, contact information, use/purpose of information, etc. The term “data elements” may refer to, inter alia, vehicle dealership details and policies, data regarding whether the vehicle is owned, rented, or leased, etc.

The term “data rating” as used herein may refer to a numeric score, a letter grade, or other indicator that may be assigned to a particular vehicle and/or in-vehicle unit based on the data handling approaches and/or the data elements associated with the vehicle and/or in-vehicle units of the vehicle that handle data of the user. The data rating or score may encompass both security and/or privacy considerations of the user's data in relation to the respective vehicle and/or in-vehicle unit. The data rating may represent a valuation of the quality of the data handling approaches with respect protection, security and privacy of the data of the user. The rata ratings or score may be presented in any appropriate format that allows users to quickly assess the security and privacy risks associated with a particular vehicle. For example, the data ratings may be presented as a star rating within a range such as from one star to five stars. In other examples, the data ratings may be presented as number within an explicit range (e.g., 0-100). In yet other example, the data ratings may be presented as a grade, such as a letter grade (e.g., A+, A, A−, B+, B, B−, . . . , D−, F). The data ratings may reflect the strengths, limitations, and weaknesses of data security and/or privacy (or data handling approaches) with respect to a vehicle and/or associated in-vehicle unit.

The term “data” as used herein may generally refer to any information associated with a user, including certain personal data, that the user does not want an unauthorized party to access, and/or data that connects back to and uniquely identifies a user. For example, the data may include the home and/or business address for the user and a contact list of individual names, addresses, phone numbers, passwords, etc. Data may further include navigational data, such as locations that the user driver to and from (e.g., a home or business or other points of interest), driver habits, etc. Data may also include financial information, such as a bank account number or credit card number, corresponding to the user of the vehicle. Data may further include substantially any other type or category information associated with the user and the respective vehicle and/or in-vehicle unit.

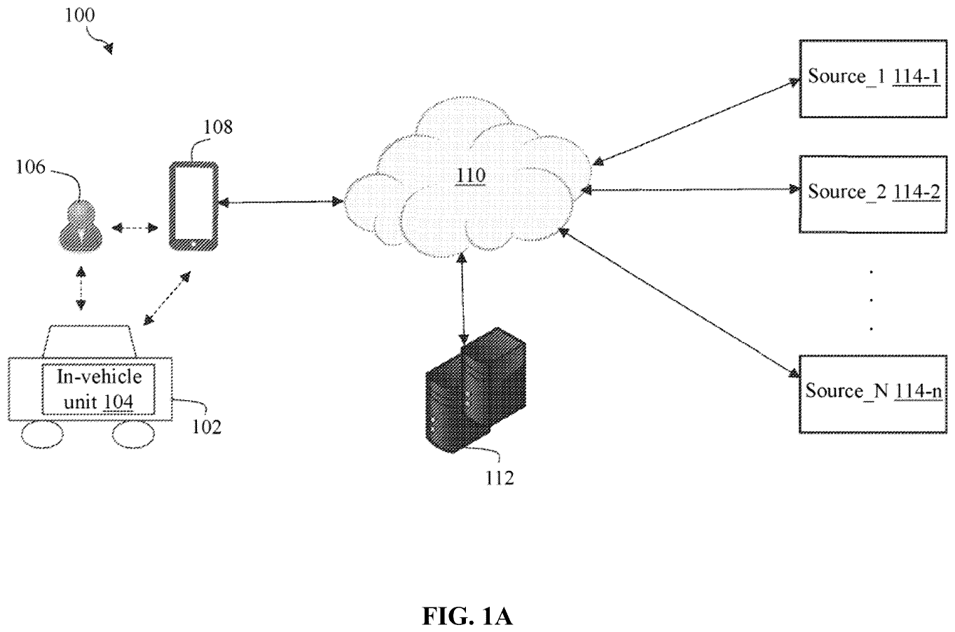

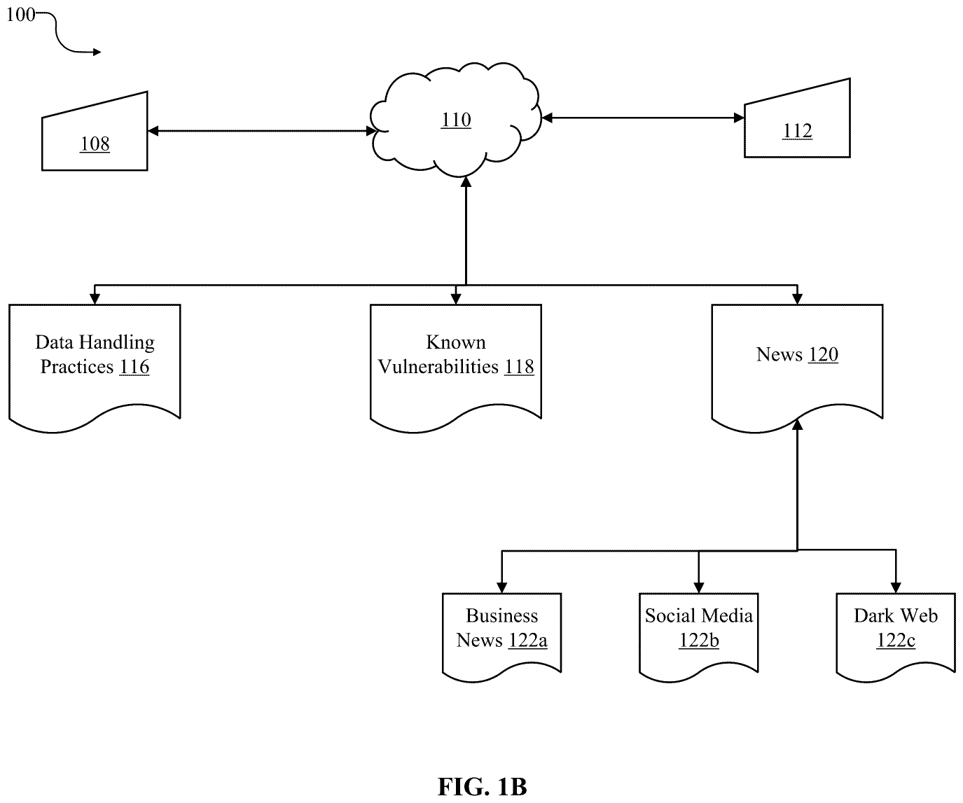

Referring now to FIG. 1A, a rating system is depicted and generally designated 100. The rating system 100 may include a vehicle 102 having one or more in-vehicle units or modules 104 that may handle data of a user 106 when used for various operations, such as, making phone calls, getting navigation information, paying toll, initiating safety assistance, initiating driving assistance such as auto-pilot or self-drive function, etc.

The vehicle 102 may include, but is not limited to, one of a number of different types of automobiles or motor vehicle, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD), hybrid vehicles, electric vehicles, motorcycles, etc.

Further, the user 106 may include either a private owner of the vehicle, other users who are related to and are authorized by the private owner to use the vehicle (e.g., spouse, kids, friends, etc.,), an individual who leases or rents the vehicle from a dealership or a rental agency, an employee of the dealership or rental agency, etc. In some example embodiments, the user 106 may be an entity, such as a rental agency, dealership, etc. The user 106 may have a user computing device 108. The user computing device 108 may be a portable computing device having display, user interaction, and/or network communication capabilities (e.g., Internet connectivity), such as, a mobile phone, a laptop, a tablet, a smart phone, any other appropriate hand held device, etc. In some example embodiments, the user computing device 108 may also include a desktop or a computing system in-built in the vehicle that has a display, user interaction, and/or network communication capabilities. The user computing device 108 may be communicatively coupled to one or more in-vehicle units 104 of the vehicle 102.

Further, the rating system 100 includes a server 112. The server 112 may be communicatively coupled to the user computing device 108 and one or more data sources (114_1, 114_2 . . . 1 14_N, hereinafter collectively 114) via a network 110. In some embodiments, the network 110 may include the Internet, a public switched telephone network, a digital or cellular network, other networks, or any combination thereof. In some embodiments, the privacy data sources 114 may include entities that publish or provide (or digital/web data repositories or web servers thereof that include) their own data handling approaches or personal data approaches of other entities, such as, but not limited to, manufacturer of the vehicle, in-vehicle unit manufacturers, in-vehicle service providers, third party businesses with whom data is shared by the manufacturers or service providers, partners associated with the manufacturers, and/or other entities that handle personal data of the user obtained from a vehicle. The data handling approaches may be published or provided online/digitally. Example of data sources, also referred to herein as “digital web content” are described in greater detail below with reference to FIG. 1B.

FIG. 1B depicts additional distributed architecture components of the rating system 100. FIG. 1B shows the user computing device 108, the network 110, and server 112, all of which may be communicatively coupled as described herein. FIG. 1B further depicts various sources or items of digital web content; namely, the data handling practices 116, the known vulnerabilities, and news 120. The news source or items of digital web content is shown as encompassing subcategories or sources or items of news, including business news 122a, social media 122b, and dark web 122c. The source or items of digital web content may generally be, or be used in connection with, any of the sources 114 described above in relation to FIG. 1A. For example, the digital web content shown in FIG. 1B may represent information sources that the system 100, as described herein may use to determine and update one or more handling approaches of a target vehicle and/or in-vehicle unit. As described herein, the digital web content may be identified, accessed and/or analyzed by use of a web crawler, third party data base and/or other means to obtain the information and ingest the information for analysis in accordance with the techniques described herein.

By way of particular, example, the data handling practices 116 may encompass a variety of security-related or security-focused practices of an entity or associated vehicle or in-vehicle device. Broadly, the data handling practices 116 may therefore encompass substantially any policy, procedure, protocol or other manner of operating that may affect the data security of a vehicle and/or in-vehicle unit. In this regard, without limitation, data handling practice 116 may include or otherwise draw from certain encryption practices, data retention practices, authentication practices, transmission practices, API practices or software bill of materials contents. Accordingly, the foregoing data handling practices 116 may be accessed in the form of a text (or convertible to text) and may be structured to include a plurality of practice topics and associated provisions. For example, a data retention practice may be identified via a document that includes various data retention topics (e.g., the duration of holding data, the time, place and manner of holding said data, deletion of said data, and so on) along with associated provisions for each said topic. Continuing the non-limiting illustration, a data retention topic for “duration of holding data” may be associated with a provision of “2 years” or other time period. As described herein, the system 100 may analyze said practice topics and associated provisions in support of updating the machine learning model and data handling approaches of the present disclosure.

Continuing the example of FIG. 1B, the known vulnerabilities 118 may encompass a variety of security-related or security-focused vulnerabilities included in the software associated with either the vehicle or the in-vehicle unit. Broadly, the known vulnerabilities 118 may therefore encompass substantially any published bug or security hole, particularly as to any open source software components in the vehicle or in-vehicle unit. In some cases, the published bugs or security holes may be determined with reference to KEV Catalog or CVE Notices. In other cases, other public (or propriety sources) of information of said bugs and security holes may be used. As described herein, the system 100 may analyze said known vulnerabilities against a software bill of materials for the respective vehicle and/or in-vehicle unit in support of updating the machine learning model and data handling approaches of the present disclosure.

Continuing the example of FIG. 1B, the news 120 may encompass a variety of security-related or security-focused news and information sources associated with either the vehicle or the in-vehicle unit. Broadly, the news 120 may encompass substantially any publicly available news or information source concerning said vehicle or in-vehicle unit, including, with limitation, from business news 122a, social media 122b, or dark web 122c. In relation to the business news 122a, such digital web content may include information form a variety of information sources of broadcast and internet publications, typically as assembled or drafted by professional journalists. In relation to the social media 122b, such digital web content may include information from a variety of social media, blog or other publications, typically as assembled or drafted by citizen journalists or amateurs. In relation to the dark web 122c, such digital web content may include information from a variety of dark web publications or forums, typically associated with criminal activity (e.g., such as a forum where criminal actors gather to buy and sell illegally obtained data). With respect to any of the foregoing sources of news 120, the information may be accessed in the form of a text (or convertible to text) and may be structured to include a plurality of topic entries and topical data. Sample topic provisions include, without limitation, a breach notification, a regulatory action, a white-hat disclosure, a black-hat announcement, an indication of data for sale, an indication of hacks for sale. A sample associated topical data may provide data for said topical entry. In this regard, continuing the non-limiting illustration, a topical entry of “breach notification” may be associated with topic data that includes the specific information of a given breach. As described herein, the system 100 may analyze said topical entry and topical data in support of updating the machine learning model and data handling approaches of the present disclosure.

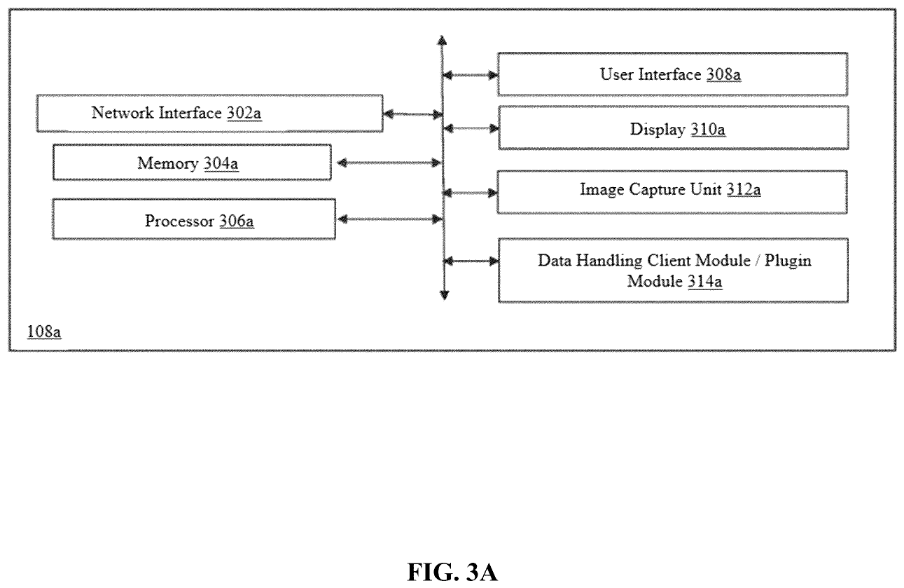

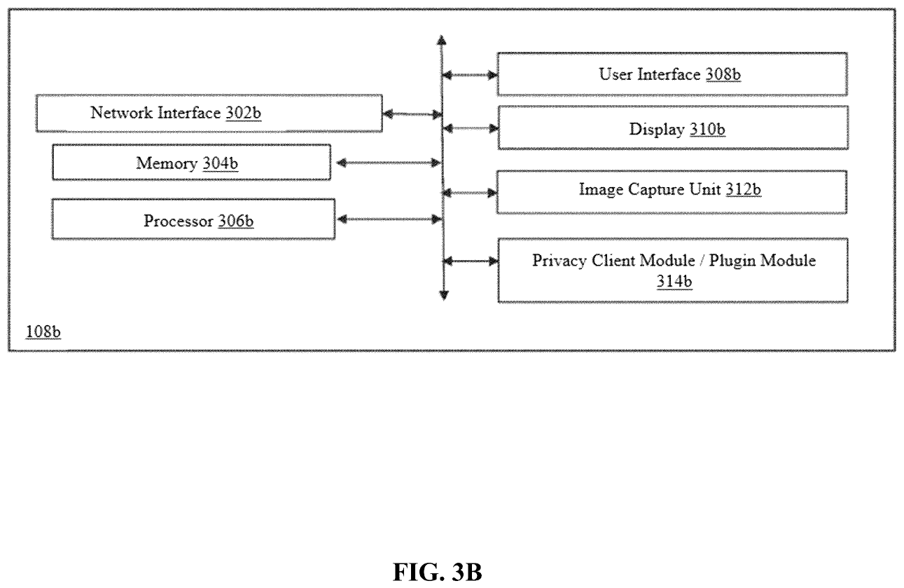

In some embodiments, continuing the discussion of the server 112, shown in relation to FIGS. 1A and 1B, the server 112 may receive data from the user computing device 108 and may provide a rating or score to the user computing device 108 in response to the data. The rating or score may be generated based on data handling approaches obtained from the privacy data sources 114 and/or at least a portion of the data received from the user computing device 108. The server 112 may be configured to use artificial intelligence to generate the ratings or scores. For example, the server 112 may use natural language processing to semantically analyze the data handling approaches (i.e., to understand what is written in the text thereof); and machine learning may be used to rate various attributes of the data handling approaches. The user computing device 108 may be configured to display the rating or score on a display 310a, 310b (shown in FIGS. 3A and 3B, respectively), such as within an Internet browser window.

In some embodiments, the data received from the user computing device 108 may be a vehicle identification number (VIN) number that uniquely identifies a vehicle. In other embodiments, the data received may be a make, model, trim, etc., of the vehicle. In yet other embodiments, the data may include an image of the vehicle or portion of the vehicle that may be used to uniquely identify the vehicle. In one or more embodiments, in addition to data identifying vehicle, the data received from the user computing device 108 may include user security or privacy preferences and/or other information (secondary information) associated with the vehicle or in-vehicle unit such as dealership associated with the vehicle, lease vs rent vs buy, in-vehicle units that are currently active and inactive, etc. Additionally or alternatively, one or more of the foregoing data items may be used to identify the in-vehicle, including identifying the in-vehicle unit separate from any identification of an associated vehicle.

Example implementations of the user computer device 108 are shown in FIGS. 3A and 3B as user computer device 108a, 108b, respectively. User computer devices 108a, 108b may be substantially analogous to one another and may configured to perform and implement the functions of the user computer device 108 described above in relation to FIGS. 1A and 1B. Notwithstanding the foregoing similarities, the user computer device 108b may implement the privacy client module/plugin module 314b, whereas the user computer device 108a may implement the data handling client module/plugin module 314a, encompassing both data privacy and data security functionality, according to the embodiments described herein. The data handling client module/plugin module 314a and the privacy client module/plugin module 314b may each communicate data to the server 112. In some embodiments, the user computing device 108 may execute a client application. The client application may provide a user interface to receive data from the user 106, such as a vehicle identification number (VIN); the make, model, trim of the vehicle; an image of the vehicle or a portion of the vehicle; privacy preferences of the user 106; data regarding whether the vehicle is (or to be) leased, rented, or bought; data regarding dealership or rental agency associated with the vehicle; or any combination thereof. The client application may transmit the data to the server 112. In response to sending the data, the client application may receive a privacy rating (associated with the vehicle) corresponding to the data and may display the privacy rating associated with the vehicle 102.

In some examples, in addition to presenting the data rating or score to the user 106 via the user computing device 108, the client application may be configured to operate in conjunction with the server 112 to present recommendations for other vehicles (makes, models, trims, year, etc.) having similar or different ratings, or steps that the user can take to change the data rating (including security and/or privacy aspects) for a given vehicle or in-vehicle unit by activating or deactivating certain in-vehicle units or changing configurations of the vehicle, etc.

Further, in some examples, the client application may provide a user interface to receive additional data from the user 106, such as requests from the user with respect to control of the user's data, including the user's personal data. For example, the client application may provide a user interface that may allow the user 106 to request a vehicle manufacturers (e.g., Nissan, GMC, Ford, etc.) associated with the user's vehicle to delete the user's information that has been collected, or request a service provider such as Sirius not to store the collected data for more than a week, etc. The client application may transmit the additional data to the server 112, the entity responsible for addressing the user's request, and/or entities responsible for regulating data handling (e.g., Office of Attorney General). Based on actions taken in response to the data control request from the user, the server 112 may be configured to adjust the data rating or score with respect to the vehicle 102. For example, if Nissan Motors complies and deletes the user's data in response to a user's request to Nissan Motors to delete the information of the user that has been collected through the user's Nissan Pathfinder vehicle, the data rating or score of Nissan Pathfinder associated with the user may be increased. If Nissan motors complies with requests from multiple users regarding Nissan Pathfinder vehicles, the data rating or score of Nissan Pathfinders may be increased in general. Similarly, in said example, if Nissan complies with a threshold percentage (e.g., at least 80%) of user requests, the data rating or score of all Nissan vehicles may be increased in general. In some examples, the additional data may indicate whether the user has activated an in-vehicle unit 104, added a new in-vehicle unit 104, or deactivated an in-vehicle unit 104. In response to sending the additional data, the client application may receive an adjusted rating and may display the adjusted rating associated with the vehicle 102.

In some example embodiments, the user computing device 108 may execute a browser application, which may include the data plugin, or privacy plugin, in certain embodiment. In response to selection of a website (i.e., a uniform resource locator (URL)), the plugin may send the URL to the server 112 through the network 106 and, in response to sending the URL, the plugin may receive the data rating or score and may display such data rating or score within the browser window. In said example embodiments with plugins 314a/314b, the user 106 may not have to explicitly input vehicle related data for the server 112 to generate a rating or score for the vehicle. Instead, the server 112 may obtain the vehicle related information from the received URL. For example, if a user opens the Ford Motors webpage on the user computing device 108 and searches for a 2019 Ford Explorer, the plugin may be configured to transmit the related URL to server 112. In said example, the server 112 may generate and provide a rating or score for 2019 Ford Explorer to the user computing device 108 which in tum may present such rating or score for the 2019 Ford Explorer on the 2019 Ford Explorer webpage that is opened in the user computing device 108. The rating or score may be overlaid on the 2019 Ford Explorer webpage, provided as a pop-up, or presented in any other appropriate manner. In said example, the user does not have to explicitly type in the details regarding the vehicle 102. Instead, the plugin obtains the information from the URL or webpage content and automatically generates and presents the privacy rating in concert with the privacy server 112.

In one example, the server 112 may be hosted on a cloud platform. However, in other examples, the server 112 may be hosted on a software as a service (SaaS) platform, or on a dedicated server in a data center without departing from a broader scope of the present disclosure.

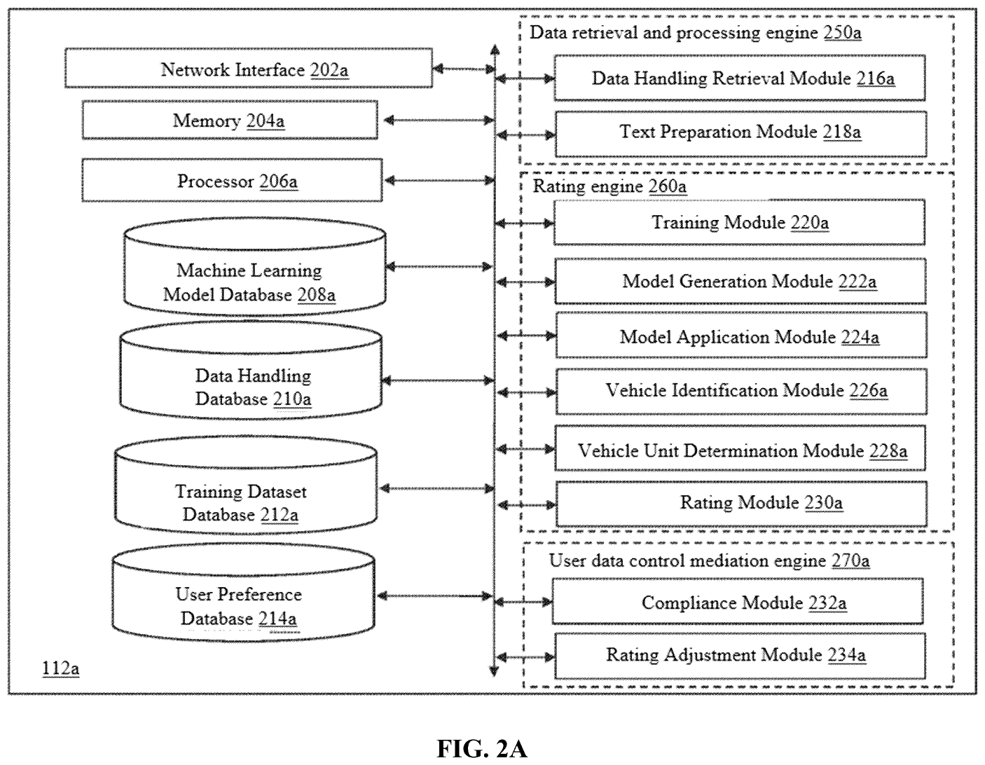

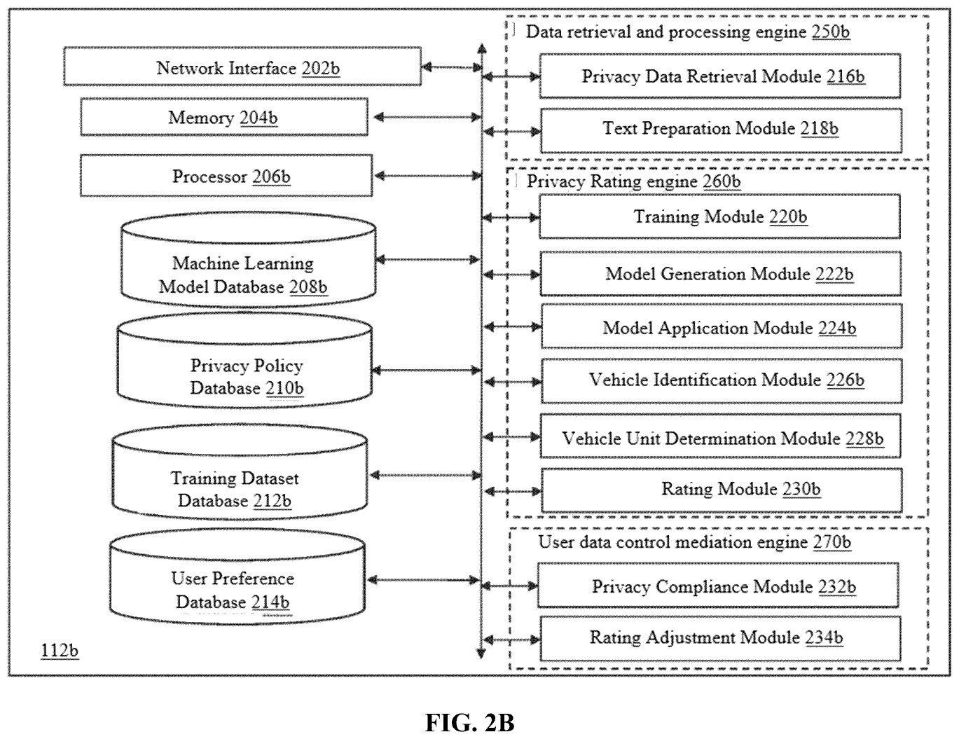

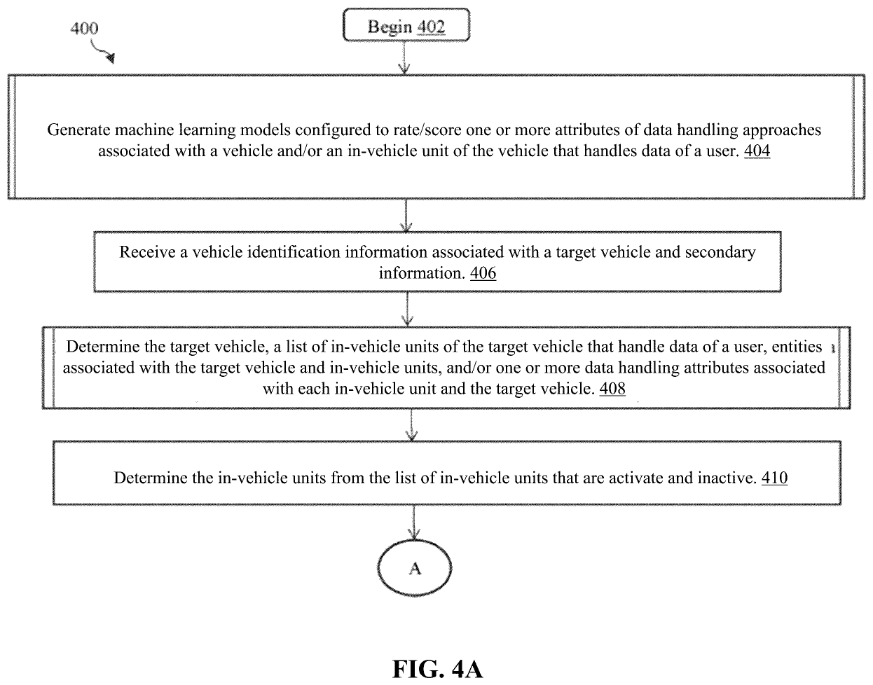

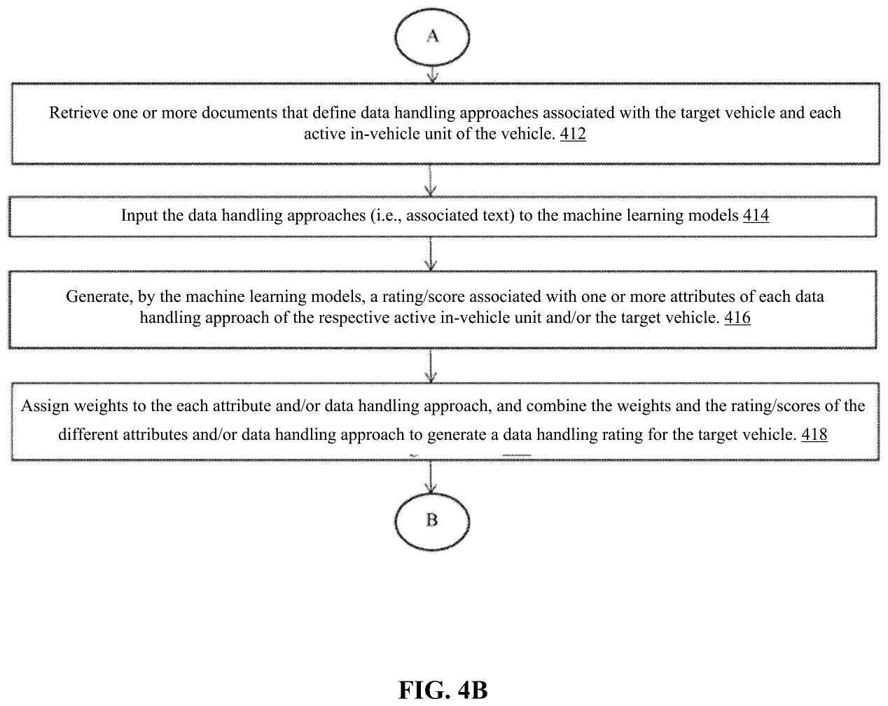

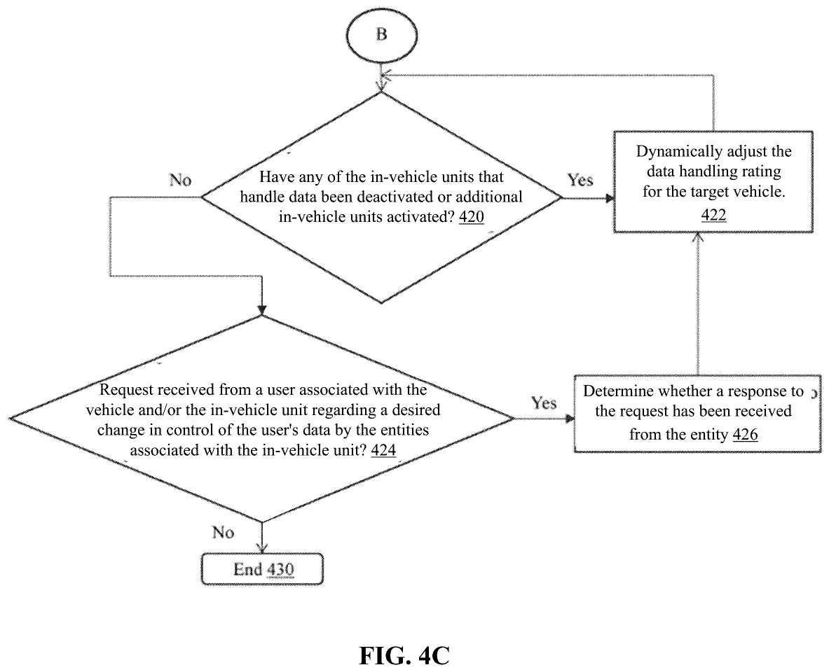

The operation of the system 100 will be described below in greater detail in association with FIGS. 4-10 by making reference to FIGS. 2A-3B which illustrates the various example components of the server 112 and the user computing device 108, according to certain embodiments. Example implementations of the server 112 as shown in FIGS. 2A and 2B as server 112a and server 112b, respectively. Servers 112a, 112b may be substantially analogous to one another and may be configured to perform and implement the functions of the server 112 described above in relation to FIGS. 1A and 1B. Notwithstanding the foregoing similarities, the server 112b may implement certain privacy-focused modules, databases and engines (e.g., a privacy data retrieval module 216b, a privacy rating engine 260b, a privacy compliance module 232b, and a privacy policy database 210b), whereas the server 112 may more broadly implements various security-and/or privacy-focused and/or synergistic module, databases and engines (e.g., a data handling retrieval module 216a, a rating engine 260a, a compliance module 232a, and a data handling database 210a). Accordingly, while reference is made herein to the components of server 112a and associated functionality, it will be appreciated that the embodiment of the server 112b may function in an analogous manner. As illustrated in FIG. 2A, in one example, the server 112a may include three engines: a data retrieval and processing engine 250a, a rating engine 260a, and a user data control mediation engine 270a. The operation of the different engines (250a-270a) of the privacy server 112a may be explained in greater detail in association with FIGS. 4-10. The operations described herein with reference to the three engines (250a-270a) may be supported by the network interface 202a, the memory 404a, and the processor 206a.

FIGS. 4-10 illustrate flowcharts associated with the operation of the data rating or scoring system. Although specific operations are disclosed in the flowcharts illustrated in FIGS. 4-10, such operations are only non-limiting examples. That is, embodiments of the present invention are well suited to performing various other operations or variations of the operations recited in the flowcharts. It is appreciated that the operations in the flowcharts illustrated in FIGS. 4-10 may be performed in an order different than presented, and that not all of the operations in the flowcharts may be performed.

All, or a portion of, the embodiments described by the flowcharts illustrated in FIGS. 4-10 can be implemented using computer-readable and computer-executable instructions which reside, for example, in a memory of the user computing device 108 (or embodiments thereof) or the server 112 (or embodiments thereof). As described above, certain processes and operations of the present invention are realized, in one embodiment, as a series of instructions (e.g., software programs) that reside within computer readable memory of a computer system and are executed by the processor of the computer system. When executed, the instructions cause the computer system to implement the functionality of the present invention as described below.

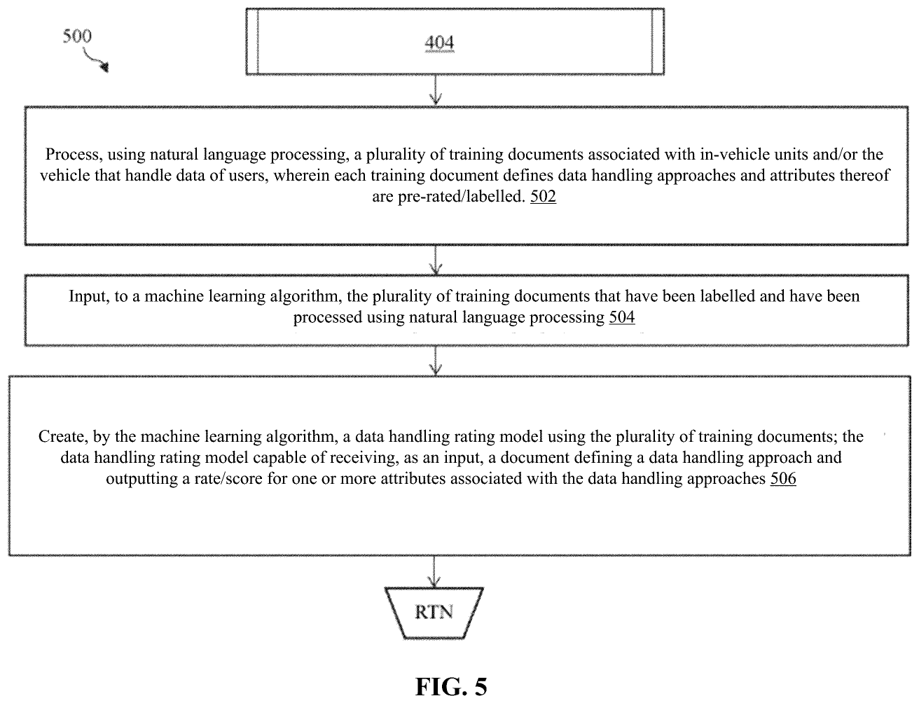

Referring to FIG. 4, a data rating generation process 400 of the system 100 begins at operation 402 and proceeds to operation 404 where a training module 220 of the server 112 may operate in concert with a model generation module 222a and a training dataset database 212a to train a machine learning algorithm to generate data rating machine learning models (including both security-and/or privacy-focused modules). The data rating machine learning models may be configured to rate one or more attributes associated with data handling approaches of a vehicle 102 and/or in-vehicle units 104 of a vehicle 102, such as any of the data handling approaches and underlying digital web content described herein. Operation 404 associated with generating the data rating machine learning model will be described in greater detail below, in association with FIG. 5.

Referring to FIG. 5, an example machine learning model generation process 500 of the server 112 (and embodiment thereof) may begin at operation 502. In operation 502, a training module 220a may process a plurality of labelled documents that define the data handling approaches associated with vehicles 102 and/or in-vehicle units 104 (hereinafter “labelled privacy documents”) using natural language processing algorithms. In one or more example embodiments, the labelled documents may include documents defining security or privacy practices or policies, terms of services, or other data handling approaches, including those data handling approaches derived from the digital web content as described in relation to FIG. 1B; where various attributes associated with the security or privacy practices or policies, terms of services, or other data handling approaches have been manually rated or scored. The various attributes associated with the security or privacy practice or policies, terms of services, or other data handling approaches may be manually scored or rated based on, inter alia, known best practices in the industry, location of the vehicle (e.g., Europe, US, Asia, etc.—Privacy laws vary in different countries), customer perception with respect to the attributes, etc. Data regarding best practices, customer perception, etc., may be obtained from external data sources like regulatory bodies, crowdsource platforms, etc. In one example, the worst practice and best practices associated with an attribute of the data handling approach may be determined and assigned the lowest rating and highest rating, respectively. Then, an objective criteria may be built for the ratings that are in between the highest and lowest ratings.

The natural language processing algorithms may be configured to extract features/feature vectors and target values associated with the labelled documents and/or various attributes of the labelled documents (including both labelled security documents and labelled privacy document). Once the labelled documents have been processed via natural language processing, in operations 504-506, the training module 220a may operate in concert with the model generation module 222s to: (a) input the features/feature vectors and target values associated with the labelled documents and/or various attributes of the labelled documents to a machine learning algorithm, and (b) responsively generate a data rating machine learning model that is trained and configured to output ratings/scores for various attributes of a data handling approach (including approaches to both privacy and security) when an unlabeled document defining the data handling approach is provided as an input. The created machine learning models may be stored in a machine learning model database 208a.

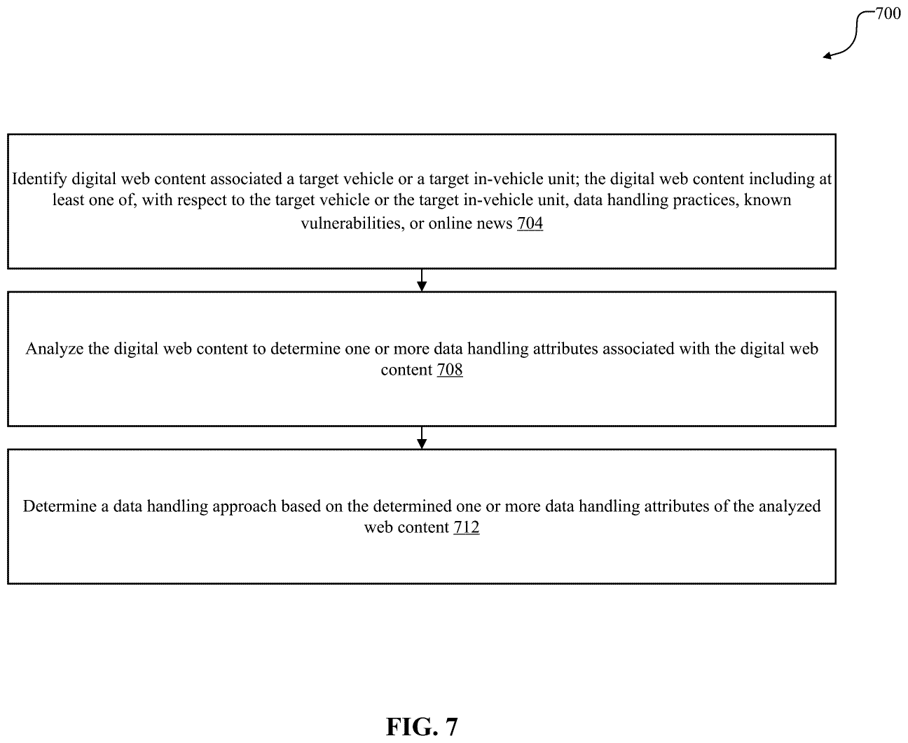

In one example, the data rating machine learning models created in operation 506 may be configured to rate three main attributes associated with a data handling approach. Further, each attribute may include sub-attributes that may be rated as well. The first attribute is related to the accessibility of the data handling approach. Examples of the first attribute and related sub-attributes may include, but is not limited to, whether policy (including data security- and privacy-focused policies) can be found easily, whether such policy is easily accessible and/or available, the number of different policies that cover a vehicle and/or in-vehicle unit, length or number of words in the policy, complexity of/ease or readability of/ability of comprehend the text of the policy, layout of the policy, availability of a table of contents section, etc. Additional factors may be analyzed in this regard for digital web content (such as those used to inform security considerations of the data handling approach), and are described below in greater detail in relation to FIGS. 7-10. The second attribute is related to the aspects of the data handling approach with respect to highly sensitive personal data. Such aspects can include, but are not limited to, data collection, protection of children, third party sharing, data security, data retention, data aggregation, control of data, privacy settings, account deletion, privacy breach notifications, policy changes, country, contact information, use/purpose of information, etc. Examples of highly sensitive personal data can include, but is not limited to, geolocation, driver habits, biometrics, etc. For example, with respect to the second attribute, a policy may be rated based on whether highly sensitive personal data is being collected and/or shared for essential services (safety, travel, etc.) or non-essential services (general/targeted ad purpose), whether the highly sensitive personal data is anonymously stored (masked) in such a way that it cannot be used to recreate user privacy information or be connected to a person, etc. According to some examples, this second attribute may be considered alongside the security practices of such highly sensitive data, including alongside the considerations of the digital web content described in relation to FIGS. 7-10 herein. The third attribute is related to features associated with an in-vehicle unit or the vehicle. Examples of such related features may include, but are not limited to, features that allow users to opt in or opt out of the user's personal data being handled, visual cues that indicate to a user that personal data is being collected; interactive cues that can be used to stop data handling, etc. In some examples, the third attribute may not be rated using a machine learning model. Instead, ratings may be pre-assigned to and stored in the data handling database 210a for each known related features of a vehicle 102 or an in-vehicle unit 104. Said ratings may be simply based on the presence or absence of the such related features.

Once the machine learning model is created, the example machine learning model generation process 500 returns to operation 406 of FIG. 4. In operation 406, the user computing device 108 may be configured to receive vehicle identification information and/or secondary information of the vehicle 102 and/or other identifying information for the vehicle and/or in-vehicle unit for which the score/rating needs to be generated (interchangeably referred to as “target vehicle” or “target in-vehicle unit”, as appropriate). The received identification information and/or the secondary information may be transmitted to the privacy server 112.

In one example embodiment, the user 106 may access the client application 314a on the user computing device 108a. The client application 314a may be downloaded and installed on the user computing device 108. Responsive to accessing the client application 314a, a processor 306a of the user computing device 108a may configured to operate in concert with a user interface module 308a and a display 312a to provide the user 106 with an interactive user interface to input the identification information and/or the secondary information. In some examples, the user interface generated by the client application 314a may be configured to prompt the user 106 to input a identification number (such as a vehicle identification number or VIN) which uniquely identifies the vehicle 102. In other examples, the user interface may be configured to prompt the user 106 to input the make, model, trim, etc., of the vehicle 102 and/or information that may be helpful in identifying an in-vehicle unit. In yet another example, the user interface may be configured to prompt the user 106 to input an image of at least a portion of the vehicle 102 and/or in-vehicle unit such as, but not limited to, an exterior of the vehicle, a dashboard of the vehicle, etc., which can be used to uniquely identify the vehicle 102 and/or in-vehicle unit. Said image may be captured using an image capture unit 312a of the user computing device 108a, or uploaded from a memory 302a of the user computing device 108a or from a web server. In some examples, the vehicle 102 may be identified using the image of the vehicle 102 or a portion of the dashboard thereof using machine learning algorithms. It will be appreciated that the foregoing functionality described by the user computing device 108a may also be performed in a substantially analogous manner by the user computing device 108b, for example, by a network interface 302b, a memory 304b, a processor 306b, a user interface 308b, a display 310b, and an image capture unit 312b; each of which may be functionality similar to corresponding components of the user computer device 108b.

In some example embodiments, in addition to the identification information, the client application 314a may be configured to generate a user interface that prompts the user 106 to input secondary information. The secondary information may be associated with the vehicle 102 and may include, but is not limited to, use, ownership, sales, dealership, rental companies, etc., associated with the vehicle. For example, whether the vehicle is purchased from Carvana, or a traditional dealership, whether the vehicle is a rental vehicle, the name of the rental agency, etc. Additionally, the secondary information may be associated with preferences of the user 106 with respect to the various attributes of the data handling approaches. For example, the user 106 can rank data collection (e.g. name, date of birth, location, address, social security number, credit card number, etc.), behavior tracking, data gathering practice, data usage (e.g. internal use only, sell to third parties, prevent fraud, essential, non-essential, etc.), op-out policy (opt-out of any data use, opt-out of some data use, opt-out is not permitted at all), etc., associated with the data handling approaches (e.g., security and/or privacy policies) in an order of importance to the user 106. The client application 314a may provide a user interface through which the user 106 may specify user preferences indicating what the user considers important, such as a relative importance of various attributes of a particular data handling approach or data handling approaches in general. For example, the user interface (e.g., GUI) may prompt the user through a series of questions designed to determine relative importance of various attributes of the data handling approaches. (e.g. “Is the collection of data for non-essential use more concerning than the data being stored indefinitely?” Yes or no.). In some embodiments, the user interface may include input fields through which a user may enter additional information that can be used to evaluate and score a data handling approach. The user preferences may be used to produce a weights for various attributes of the data handling approaches. In some examples, additional factors may be taken into account to determine the weights. For example, the country in which the vehicle is located, privacy laws in the area, etc. The weights may be used to influence the overall rating/score for a vehicle 102.

The received data (secondary information and/or vehicle identification information and/or other identification information) may be transmitted to the server 112 via a network interface 302a of the user computing device 108a. Additionally, a user identifier may be transmitted to the server 112. The server 112 may be configured to store the data received from the user computing device 108 (i.e., the user identifier, the vehicle identification information, and the secondary information) in a user preference database 214a. The user identifier can be used to retrieve the user preferences for that user from the user preference database 214a.

Alternatively, in operation 406, the plugin 314a may be configured to automatically transmit information associated with a vehicle 102 when the user 106 accesses a vehicle related webpage via the user computing device 108a. For example, the privacy plugin 314a may be configured to transmit vehicle related information when the user 106 accesses a vehicle manufacturer webpage and searches for a specific make and model of a vehicle; or the privacy plugin 314a may be configured to transmit vehicle related information when the user 106 accesses a dealership webpage, rental webpage, etc., and searches for a specific vehicle of interest to the user 108.

In some example embodiments, in operation 406, the client application 314a may be configured to automatically determine the identification information and/or the secondary information. In said example embodiments, the client application 314a may interact with other modules of the user computing device 104 such as Bluetooth module, Geolocation module, etc., (not shown in FIGS. 3A or 3B) to automatically determine the vehicle identification information and/or the secondary information.

In some example embodiments, the client application 314a may interact with other modules of the user computing device 104 (as mentioned above) to automatically determine at least a portion of the identification information and/or the secondary information, and the remaining portion may be obtained from the user 106. For example, the user computing device 108 may be paired with a personal vehicle 102 of the user 106 via Bluetooth. Said pairing information may be stored in a memory 304 of the user computing device 108 by the Bluetooth module for automatic pairing each time the user 106 operates the vehicle 102. Further, the geolocation module of the user computing device 108 may have identified and stored the most commonly visited locations and or driving patterns of the user 106 in the memory 304a. So, in said example, when the user 106 accesses the client application 314a, the client application 314a may be configured to operate in concert with the geolocation and Bluetooth module and use the data stored in the memory 304a to determine if the user computing device 108 is paired with a different vehicle other than the ones with which the user 106 generally interacts, if the user 106 is outside of the commonly visited locations, and/or the driving pattern of the user 106 is different from the usual driving patterns. If the user 106 is in a different location such as the location of a rental agency or if the user computing device 108 is paired to a vehicle associated to a rental agency, the client application 314a may be configured to prompt the user to confirm that the vehicle 102 is a rental vehicle and/or provide/confirm the name of the rental agency, etc. In some examples, by virtue of being connected to the vehicle 102 (i.e., systems of the vehicle (e.g., infotainment, etc.)), the client application 314a may be able to retrieve the VIN number of the vehicle 102 and thereby a history associated with the vehicle 102 which can then be confirmed by the user 106. It is noted that the client application 314a is configured to notify and/or receive consent from the user 106 prior to automatically retrieving any vehicle related information for the purpose of generating any rating, including those associated with either or both of a privacy rating or a security rating.

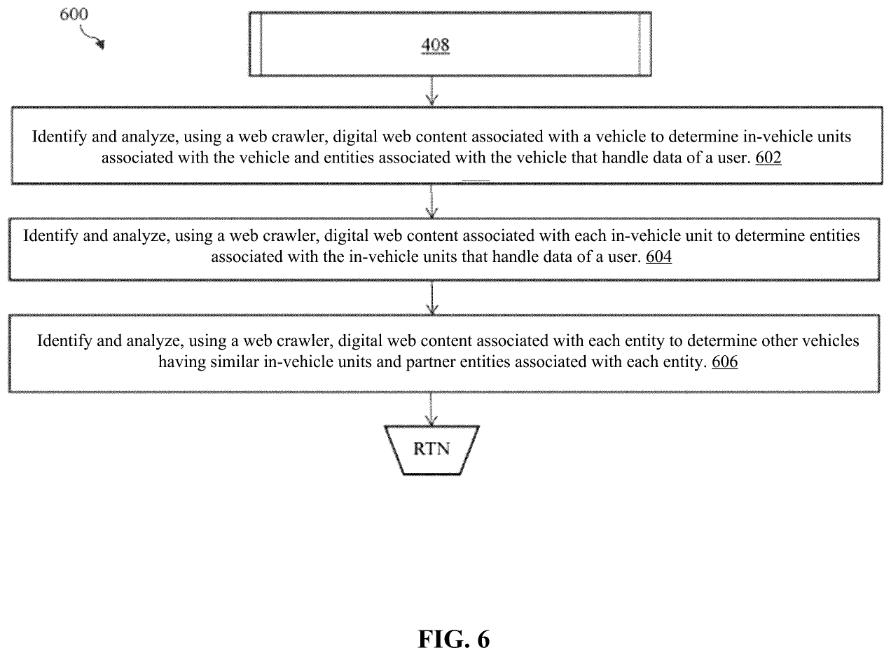

Responsive to receiving the identification information and/or the secondary information, in operation 408, a processor 206a of the privacy server 112a may operate in concert with a vehicle identification module 226a and a vehicle unit determination module 228a of the rating engine 260a to determine: (a) the vehicle 102, (b) in-vehicle units 104 associated with the vehicle 102, and (c) entities associated with the vehicle 102 and in-vehicle units 104 that are involved in handling the data of the user 106. Operation 408 will be described in greater detail below, in association with FIG. 6. Additionally or alternatively, operation 408 may be performed or supplemented with the operations as described below in association with FIGS. 7-10.

Referring to FIG. 6, a data acquisition process 600 begins with operation 602. In operation 602, the vehicle identification module 226a of the server 112a may be configured to uniquely identify the vehicle 102 based on the identification information received from the user computing device 108 and/or the in-vehicle unit. Responsive to identifying the vehicle 102 (e.g., make, model, year, trim, etc. of the vehicle 102) and/or in-vehicle unit, the vehicle identification module 226a may operate in concert with a vehicle unit determination module 228a to determine all the in-vehicle units 104 and/or all the entities (e.g., manufacturer, assembler, etc.) associated with the vehicle 102 that handle personal data of the user 106, as applicable. In some examples, the in-vehicle unit 104 and/or entities associated with the vehicle 102 may be determined from digital web content (e.g., websites) associated with the vehicle 102 such as, but not limited to, the vehicle manufacturers website. Additional operations with regarding to obtaining, analyzing and handling such digital web content, for example as such content relates to data security considerations is discussed in greater detail below in relation to FIGS. 7-10. Further, in operation 604, the vehicle identification module 226 and the vehicle unit determination module 228 may operate in concert to identify and analyze digital web content associated with each in-vehicle unit 104 of the vehicle 102 to determine entities (e.g., OEMs, third party service providers, etc.) associated with the in-vehicle unit 104 that handle the data of the user 106. Furthermore, in operation 606, the vehicle identification module 226a and the vehicle unit determination module 228a may operate in concert to identify and analyze digital web content associated with the entities (i.e., entities associated with the vehicle and each in-vehicle unit) to determine all the vehicles that have a particular in-vehicle unit 104 and/or to identify partners of each entity (e.g., entities with which the personal data is shared) that are associated with handling the data of the user. In other words, the vehicle information is used to identify in-vehicle units 104 associated with the vehicle 102. Then, information associated with the in-vehicle units 104 are gathered to determine all vehicles 102 having said in-vehicle units 104, thereby achieving a circular verification process. The circular verification process where the vehicle information is used to identify in-vehicle units 104 of the vehicle 102, and using in-vehicle unit information to identify all vehicles (including vehicle 102 of interest) that have said in-vehicle units 104 improves the accuracy of the data acquisition process 500. Responsive to completing the data acquisition process 500, the data acquisition process 600 returns to operation 410 of FIG. 4.

In one example embodiment, an Internet bot (e.g., web crawler) may be used to automatically crawl/browse the digital web pages referenced in operations 602-606. The Internet bot may be a software application that runs automated tasks over the Internet. That is, in operations 602-606, a web crawler may be configured to crawl the webpages associated with the vehicle manufacturer, OEMs associated with the in-vehicle units, partners of the manufacturer and/or OEMs, etc. In another example embodiment, the server 112a may be configured to query one or more of the sources 114 (including the digital web content described in relation to FIG. 1B) to obtain data associated with the vehicle 102, in-vehicle units 104, and/or the data handling approaches thereof.

In some examples, the digital web content (i.e., text of the webpage) may be semantically analyzed using artificial intelligence (natural language processing and/or machine learning) to determine the in-vehicle units 104 of a vehicle 102, entities associated with the vehicle 102, and/or partners associated with the entities that handle data of the user 106. Additionally, in operations 602-606, the digital web content (i.e., text of the webpage) may be semantically analyzed using artificial intelligence to automatically retrieve data handling approaches (i.e., the text of the security and/or privacy policies, security and/or privacy practices, security and/or privacy features, etc.) of the entities associated with the vehicle 102 and/or the in-vehicle units 104. That is, in operations 602-606, in addition to identifying the entities (e.g., manufacturers, OEMs, third parties, partners, etc.) associated with the vehicle 102 and/or the in-vehicle units 104, said bots may fetch text or documents associated with the data handling approaches from various websites and may provide the fetched data to the server 112a.

Upon receipt of the data handling approaches, the server 112a may store the text and an associated source information in the data handling database 210a. In some examples, data handling approaches may be identified amongst other types of web pages based on a set of regular expressions, assuming that a data handling approach (e.g., security and/or privacy policy, ToS, etc.) may be detected according to the presence of certain key-words and patterns. If the number of regular expressions identified in a web page is greater than a certain threshold, then it may be tagged as being associated with data handling approaches. In other example embodiments, any other appropriate methods may be used to identify and retrieve the data handling approaches. In one or more examples, each data handling approach (i.e., documents associated therewith) stored in the data handling database 210a may be linked to/associated with an in-vehicle unit 104 and/or a vehicle 102.

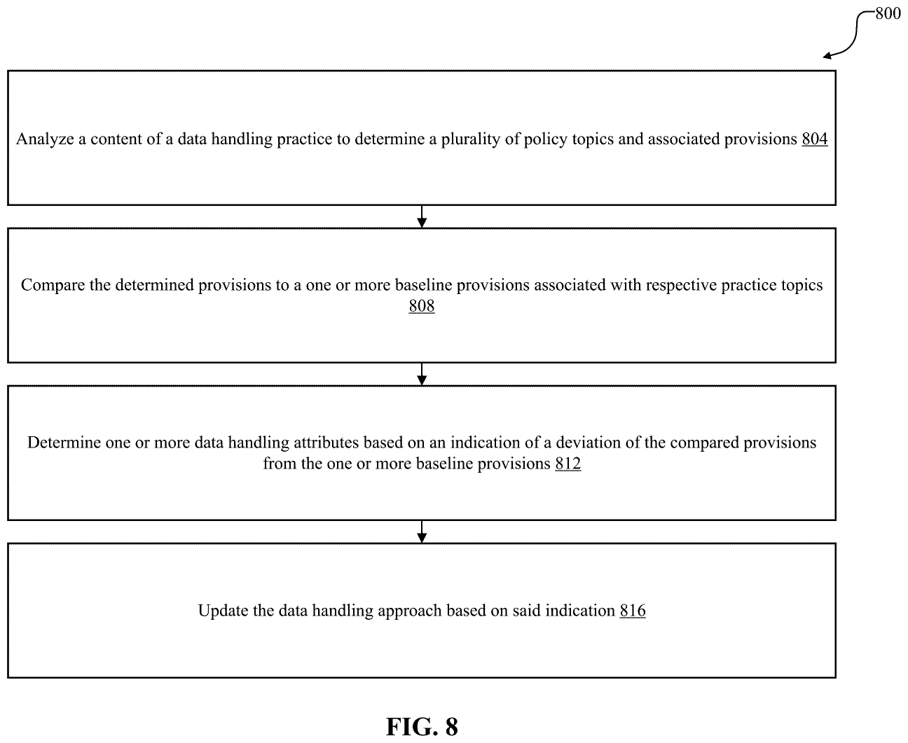

Turning to FIG. 7, a process for determining one or more data handling approaches based on digital web content is depicted. For example, and as described herein, the systems of the present disclosure may be configured to determine one or more data handling approaches based on certain items of digital web content. Example digital web content may include, as non-limiting examples, data handling practices, known vulnerabilities, and online news; examples of which are described in greater detail above in relation to FIG. 1B. All such digital web content may include information indicative of certain security considerations of a target vehicle and/or target in-vehicle unit. For example, broadly, the data practices may include or be associated with certain encryption practices, data retention practices, authentication practices, transmission protocol practices and/or software bills of materials. Further, the known vulnerabilities may include or be associated with certain published bugs and security holes, such as those identified within software components of a target vehicle and/or in-vehicle unit. Further, the online news (including business news, social media, and dark web) may include or be associated with certain updates concerning, for example, a breach notification, a regulatory action, a white-hat disclosure, a black-hat announcement, an indication of data for sale, an indication of hacks for sale. As described below with reference to FIG. 8, such data practices, known vulnerabilities and/or news may be scraped or accessed via a proprietary database in order to glean one or more attributes in support of the machine learning module techniques described herein.

In this regard, at operation 704, digital web content associated with a target vehicle or a target in-vehicle unit is identified. The digital web content includes at least one of, with respect to the target vehicle or the target in-vehicle unit, data handling practices, known vulnerabilities, or online news. For example, and with reference to FIGS. 1B and 2A, the server 112a may be operable to identify digital web content included in a proprietary database and/or through use of a web crawler, such as any of the web crawlers described herein. The server 112a, in this regard may identify any of the data handling practices 116, known vulnerabilities 118 and/or news 120, described in relation to FIG. 1A. Further, the server 112a may identify any such items of digital web content as may be associated with a target vehicle and/or in-vehicle unit, for example, by operation of the vehicle identification module 226a, the vehicle unit determination module 228a and/or the rating engine 260a and/or the data retrieval and processing engine 250a more generally, as described herein.

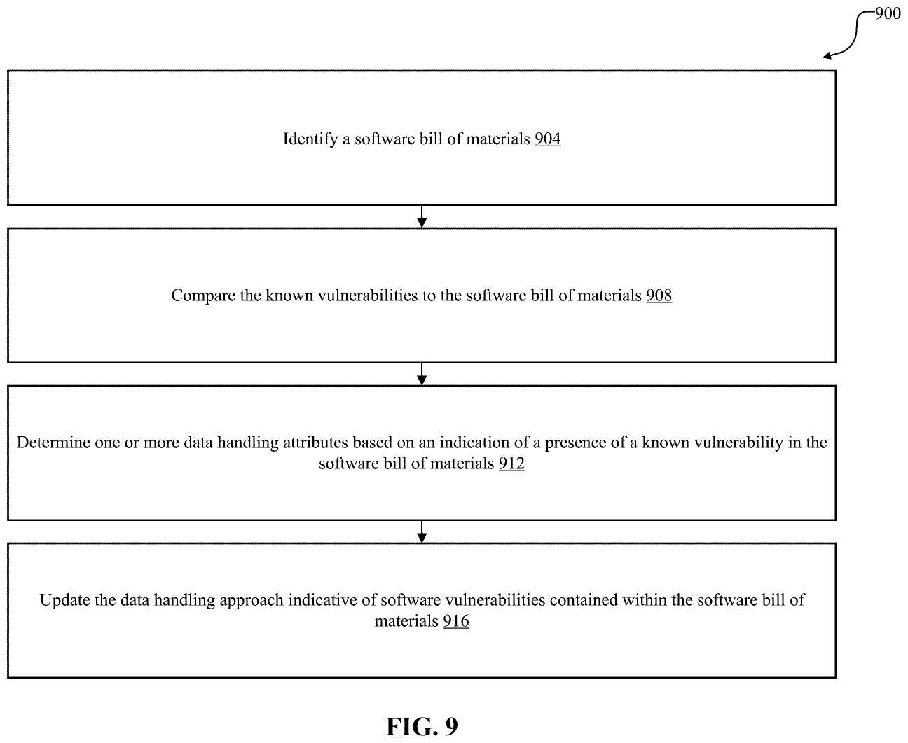

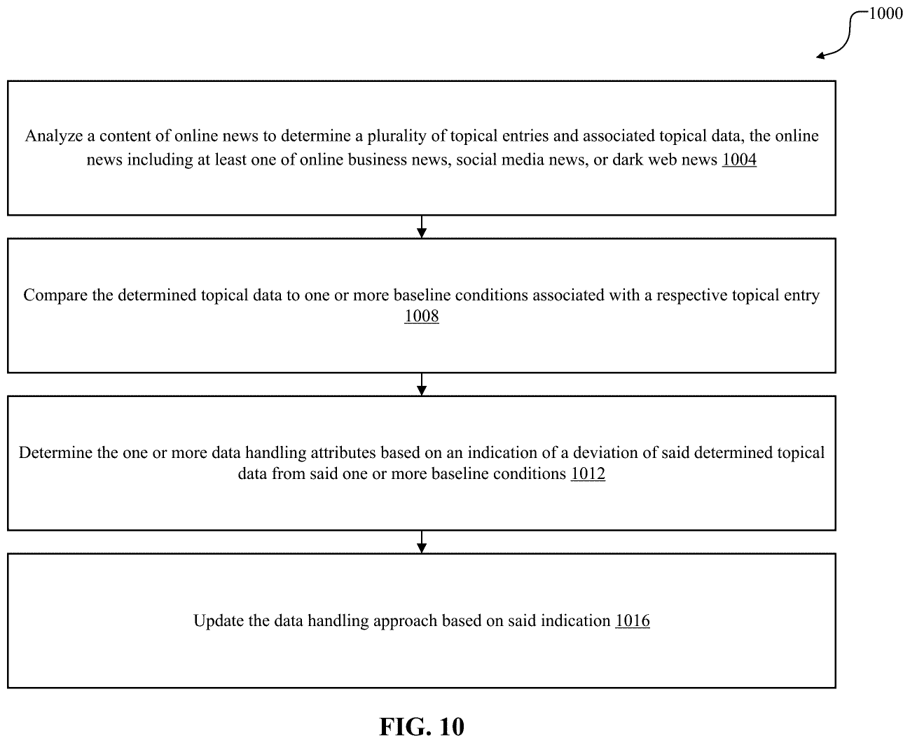

At operation 708, the digital web content is analyzed to determine one or more data handling attributes associated with the digital web content. For example, and with reference to FIGS. 1B and 2A, the digital web content, including any of the data handling practices 116, known vulnerabilities 118 and/or news 120 may be semantically analyzed by any of the using artificial intelligence (e.g., natural language processing and/or machine learning) techniques and modules described herein. Additional details of operations of semantically analyzing of the data handling practices are discussed below in greater detail in relation to FIG. 8. Additional details of operations of semantically analyzing of the known vulnerabilities are discussed below in greater detail below in relation to FIG. 9. Additional details of semantically analyzing of the online news are discussed in greater detail below in relation to FIG. 10. In all such cases, the sematic analysis (and/or other analysis) may support gleaning of information from such digital web content in support of the machine leaning module techniques described here for generating of a security or privacy rating/score for the user.

For example, at operation 712, a data handling approach is determined or updated based on the determined one or more data handling attributed of the analyzed web content. For example, and with reference to FIGS. 1B and 2A, the data handling database 210a may be updated based on the semantic analysis of the associated digital web content. For example, with reference to a given target vehicle and/or in-vehicle upon, responsive to the semantic analysis, new information may be present that updates (increases, decreases or otherwise alters) the data approach of the target vehicle and/or in-vehicle unit. Such updated data handling approach may then in turn be used to optionally create labelled documents to fine tune and update the machine learning module, while also being used to determine the rating/score for the respective target vehicle and/or in-vehicle unit, in each case, in accordance with the techniques described herein.

Turning to FIG. 8, another process for determining one or more data handling approaches based on digital web content, including data handling practices, is depicted. By way of particular example, FIG. 8 depicts a process of semantic analysis of digital web content (such as that discussed generally above in relation to FIG. 7) for digital web content constituting data handling practices. In this regard, at operation 804, a content of a data handling practice is analyzed to determine a plurality of policy topics and associated provisions. For example, and with reference to FIGS. 1B and 2A, the server 112a may be configured to analyze, such as semantically analyze, the data handling practice 116. For example, the data retrieval and processing engine 250a and/or the rating engine 260a may be configured to parse and identify certain portions of text of the data handling practices to determine, e.g., a plurality of practice topics and associated provisions, such as those described above in relation to FIG. 1B. At operation 808, the determined provisions are then compared to one or more baseline provisions associated with respective practice topics. As discussed above in relation to FIG. 1B, data handling practices may include one or practices or “topics” associated with, or otherwise constituting, encryption, data retention, authentication, transmission protocols, APIs, and/or software bills of materials. As one non-limiting example, a data retention topic may be parsed to determine a topic for “length of holding data” and to determine a value of said topic as “2 years”, as an illustration. Continuing the non-limiting illustration, the value of said of topic being “2 years” may then be compared with a baseline provision (such as an acceptable industry standard) in order to glean information about the identified information. For example the “2 years” may be compared to a hypothetical industry standard of “1 year”. In this regard, at operation 812, one or more data handling attributes are determined based on an indication of deviation of the compared provisions from the one or more baseline provisions, such as a deviation of the “2 years” from the “1 year”, in such example. Responsive to this determination, at operation 816, the data handling approach is updated based on said indication. For example, and with reference to FIG. 2A, the server 112a may operate to update the data handling approach by inputting such approach and updates to the data handling database 210a in support of subsequent accessing by the machine learning modules described herein.

Turning to FIG. 9, another process for determining one or more data handling approaches based on digital web content, including known vulnerabilities, is depicted. By way of particular example, FIG. 9 depicts a process of semantic analysis of digital web content (such as that discussed generally above in relation to FIG. 7) for digital web content constituting known vulnerabilities. In this regard, at operation 904, a software bill of materials is identified. For example, and with reference to FIGS. 1B and 2A, the server 112a may be configured to obtain a software bill of materials associated with a given target vehicle and/or in-vehicle unit. For example, the vehicle identification module 226a and/or the vehicle unit determination module 228a (or, more broadly, the functionality of data retrieval and processing engine 250a and rating engine 260a described herein) may access a software bill of materials, e.g., by accessing proprietary databases and/or by crawling the web, to identify open source and/or other software components contained with the respective target vehicle and/or in-vehicle unit. At operation 908, known vulnerabilities are compared to the software bill of materials. For example, the server 112a, in conjunction with said identifying of the software bill of materials, may additionally identify and/or maintain an ongoing repository or storage of certain known vulnerabilities, including published bugs or security holes in open source software components. This information may be stored in one or databases of the server 112a and may optionally be obtained from KEV Catalog or CVE Notices. The operation of 908 may involve comparing such known vulnerabilities to the software bill of materials for the respective target vehicle and/or target in-vehicle unit. In turn, at operation 912, one or more data handling attributes are determined based on an indication of a presence of a known vulnerability in the software bill of materials. For example, the server 112a may determine a data handling approach based on the software bill of materials for the target vehicle and/or target in-vehicle unit including said known vulnerability. Responsive to this determination, at operation 916, the data handling approach is updated indicative of software vulnerabilities contained within the software bill of materials. For example, the server 112a may operate to update the data handling approach by inputting such approach and updates to the data handling database 210a in support of subsequent accessing by the machine learning modules described herein.

Turning to FIG. 10, another process for determining one or more data handling approaches based on digital web content, including online news, is depicted. By way of particular example, FIG. 10 depicts a process of semantic analysis of digital web content (such as that discussed generally above in relation to FIG. 7) for digital web content constituting online news. In this regard, at operation 1004, a content of the online news is analyzed to determine a plurality of topical entries and associated topical data. The online news includes at least one of online business news, social media news, or dark web news. For example, and with reference to FIGS. 1B and 2A, the server 112a may be configured to analyze, such as semantically analyze, the online news 120 (including the business news 112a, social media 122b, and dark web 122c). For example, the data retrieval and processing engine 250a and/or the rating engine 260a may be configured to parse and identify certain portions of text of the online news 120 to determine, e.g., a plurality of topical entries and associated topical data, such as those described in relation to FIG. 1B. At operation 1008, the topical data is compared to one or more baseline conditions associated with a respective topical entry. As discussed above in relation to FIG. 1B, online news may include various topical entries include a breach notification, a regulatory action, a white-hat disclosure, a black-hat announcement, an indication of data for sale, an indication of hacks for sale. As one non-limiting example, a topic entry may be parsed to determine a topical entry for “a breach notification” and to determine a value of said topical entry as “yes, software vendor ABC breached.” The value of the topical entry may also include details of the breach, including severity and data breached. Continuing the non-limiting illustration, the value of said topical entry being “yes, software vendor ABC breached” may then be compared with a baseline condition (such as the absence of a breach, in this example) in order to glean information about the online news. In this regard, at operation 1012, the one or more data handling attributes are determined based on an indication of a deviation of said determined topical data from said one or more baseline conditions, such as a deviation from an absence of a breach and/or the extent or severity of a breach, as indicated by the online news. Responsive to this determination, at operation 1016, the data handling approach is updated based on said indication. For example, and with reference to FIG. 2A, the server 112a may operate to update the data handling approach by inputting such approach and updates to the data handling database 210a in support of subsequent accessing by the machine learning modules described herein.

In some cases, in connection with the method 1000 described in FIG. 10, multiple items of online news may be semantically analyzed into to inform the data handling approach. Accordingly, the server 112a may be further configured to update the data handling approach based in part on a relative reliability of the specific item of online news, with business news 122a generally being considered more reliable than social media 122b, and social media 122b generally being considered more reliable than dark web news 122c. In this regard, in certain examples, the operation 1016 may further include updating the data handling approach to a great extent based on the online news having a greater reliability as compared to the online news having a lesser relative reliability.

Returning to FIG. 4, in operation 410, the server 112a may operate in concert with the client application 314a of the user computing device 108a to determine which ones of the plurality of in-vehicle units 104 are currently active and/or have been de-activated (e.g., by the user 106, or past subscription period, etc.). In one example, a vehicle unit determination module 228a of the server 112a may send a request to the user computing device 108a to determine the in-vehicle units 104 that are active and inactive. The request may include a list of in-vehicle units 104 associated with the vehicle 102 determined as part of the data acquisition process 600. Responsive to receiving the request, the client application 314a of the user computing device 108a may operate in concert with the user interface module 308a and the display 310a to generate a user interface that prompts the user 106 to select the in-vehicle units 104 that are active and the in-vehicle units 104 that are inactive. Identifying the in-vehicle units 104 that are active and inactive helps to generate a more customized and accurate security and/or privacy rating for the vehicle 102. In some examples, the user computing device 108a may be communicatively coupled (e.g., paired or connected) to the vehicle 102 (i.e., the different in-vehicle units 104 thereof). As such, information regarding the in-vehicle units 104 that are active may be automatically determined by the client application 314a by identifying the in-vehicle unit 104 that are communicatively coupled to the user computing device 108a. Alternatively, the in-vehicle units 104 that are active may be determined both automatically and/or based on input from the user 106. It is noted that in some examples, operation 410 may be omitted. That is, operation 410 is optional. In said examples where operation 410 is omitted, a general security and/or privacy rating or score may be generated for the vehicle 102 based on the assumption that all the in-vehicle units 104 associated with the vehicle 102 identified by the data acquisition process 600 are active.

In some examples, in addition to requesting the user 106 to provide information regarding in-vehicle units 104 that are active and/or inactive, the client application 314a may be configured to request the user 106 to confirm that the list of the in-vehicle units 104 identified by the data acquisition process 600 is accurate. Further, the client application 314a may be configured to request the user 106 to confirm that vehicle 102 and the entities associated with the vehicle 102 and/or in-vehicle units 104 (e.g., ones that handle data of the user 106) identified as part of the data acquisition process 600 are accurate. If a certain in-vehicle unit 104 identified as part of the data acquisition process 600 is not present in the vehicle 102, or if the vehicle 102 and/or entities identified as part of the data acquisition process 600 are inaccurate; said information may be provided as feedback to server 112a. The feedback may be used by the artificial intelligence algorithms associated with the data acquisition process 600 to learn, adapt, and improve accuracy of the process 600.

Responsive to determining the in-vehicle units 104 that are active, said information may be transmitted to the server 112. In operation 412, a data retrieval module 216a of the server 112a may be configured to retrieve data handling approaches (i.e., documents and/or texts associated therewith/defining the data handling approaches) associated with the vehicle 102 and/or each active in-vehicle unit 104. The data handling approaches may be retrieved from the data handling database 210a. Then, in operation 414, the retrieved data handling approaches may be provided as input to the rating machine learning models created in operation 402. In one or more examples, prior to providing the data handling approaches as input to the rating machine learning models, a text preparation module 218a may be configured to process the text associated with the data handling approaches. The processing may include, but is not limited to, cleaning the text (e.g., removing HTML tags, stop words, and punctuations; stemming, etc.), formatting the text, converting the text to feature vectors using natural language processing, etc.

Once the data handling approaches are provided as input to the rating machine learning models, in operation 416, the rating machine learning models may be configured to assign a rating/score for one or more attributes and/or sub-attributes of each data handling approach. In one example embodiment, the rating machine learning models may be configured to generate a rating/score for three main attributes (and/or sub-attributes) associated with a data handling approaches as described above in association with operation 402 of FIG. 4. In other words, in said example, responsive to receiving data handling approaches (i.e., text or document), the rating machine learning models created in operation 402 are configured to generate a rate/score for the: (a) accessibility related attributes, (b) attributes associated with data security and/or privacy aspects of the data handling approaches with respect to highly sensitive personal data and/or any other user data more generally as it relates to the vehicle and/or in-vehicle unit, and/or (c) attributes associated with security and/or privacy related features of the in-vehicle unit or the vehicle. It is noted that the three main attributes described above are examples and are not limiting. That is, in other example embodiments, the rating machine learning models may be configured to generate a rating/score for fewer or more than three attributes associated with a data handling approaches without departing from a broader scope of the present disclosure. Further, as described above in association with operation 402, in some examples, one or more attributes of the data handling approaches may be rated or scored without using a machine learning model.

Responsive to generating a rating/score for one or more attributes (and/or sub-attributes) of each data handling approach, in operation 418, a rating module 230a may be configured to retrieve the user preferences associated with the user 106. Further, in operation 418, the rating module 230a may assign weights to each sub-attribute, attribute, and/or data handling approach based on the user preferences. For example, if a user has ranked the accessibility attribute as being of lower importance relative to attributers of the data privacy aspects, security aspects, and/or other aspects with respect to highly sensitive personal data, a lower weight may be assigned to the accessibility attribute compared to that of said other aspects. In some examples, the weights for the attributes and sub-attributes of a data handling approach may be assigned based on user-preference; and weights for each data handling approach may be assigned based on the user preference and/or at least a portion of the secondary information. For example, different weights may be assigned to a data handling approach of Carvana vs Local dealership vs Enterprise. The weights may be used to influence the overall rating/score. The assigned weights are multiplied with the score for each sub-attribute, attribute, and/or the data handling approach; and the results are summed (or averaged or combined in any appropriate manner) to create an overall rating/score (including security and privacy scores) for the vehicle 102. The weights give each sub-attribute, attribute, and/or data handling approach a larger or smaller impact on the final score based on attributes that are more or less important. A representative example will be discussed below to help give a more concrete representation of these concepts.

An overall rating/score for the vehicle that is based on data handling approaches of different entities associated with the vehicle 102 and/or the in-vehicle units 104 creates an incentive for entities to push each other to improve their data handling approaches even down to the level of various attributes and sub-attributes. For example, the rating/score of Ford Focus may depend on the individual rating/score of data handling approaches (e.g., security and/or privacy policies, practices, features, etc.) of Ford, Sirius XM service provider, OnStar service provider, Bose infotainment system, Sync 3 online functionality service, etc. In said example, a low rating/score of data handling approaches or a data collection attribute of the data handling approach associated with at least one of the entities listed above will lower the overall privacy rating/score for Ford Focus. As such, there is incentive for Ford Motors to push/drive itself and other entities listed above to improve their data handling approaches (and attributes or sub-attributes associated therewith) and thereby increase the overall privacy rating/score for Ford Focus.

In one example, in operations 414-418, the model application module 224a may generate a rating/score for each sub-attribute of each attribute of each data handling approach. Then, the rating/score associated with each sub-attribute may be multiplied with a weight value that is assigned to the respective sub-attribute. Responsively, the weighted ratings/scores of the sub-attributes of an attribute are combined to create the rating/score for an attribute of a data handling approach. Similarly, ratings/score for each of the other attributes of the data handling approach may be created. The rating/score of each attribute of the data handling approach may be multiplied with a weight value that is assigned to the respective attribute. The weighted ratings/score of the attributes of the data handling approach are combined to create the rating/score for the data handling approach. Similarly, ratings/score for each of the data handling approaches of a vehicle and/or in-vehicle unit may be created. Further, the rating/score of each data handling approach may be multiplied with a weight value that is assigned to the respective data handling approach. The weighted ratings/scores of the data handling approaches are combined to create the rating/score for the vehicle. In the above example, the weights may be normalized and can be between 0 and 1 (including both 0 and 1). The said example of generating a privacy rating/score for a vehicle may be represented by the following formula:

$${S}_{v} = {\sum }_{i = 0}^{n} ( {W}_{pai} {\sum }_{j = 0}^{m} ( {W}_{aj} {\sum }_{k = 0}^{o} ( {W}_{sa \_ k} ( {S}_{sak} ) ) ) )$$

$$where ,$$

$${S}_{a} = {\sum }_{k = 0}^{o} ( {W}_{sa \_ k} ( {S}_{sak} ) )$$

$${S}_{pa} = {\sum }_{j = 0}^{m} ( {W}_{a \_ j} ( {S}_{sj} ) )$$

i=number of different data handling approaches associated with the vehicle and/or in-vehicle units
j=number of attributes associated with each data handling approach
k=number of sub-attributes associated with each attribute
Wₚₐ=weight value assigned to a data handling approach
Wₐ=weight value assigned to an attribute
Wₛₐ=weight value assigned to a sub-attribute
Sₚₐ=Rating/Score of a data handling approach
Sₐ=Rating/Score of an attribute
Sₛₐ=Rating/Score of a sub-attribute
Sᵥ—Privacy rating/score (Overall privacy rating/score) of vehicle

In some examples, while each sub-attribute may be assigned a weight and multiplied with said weight to generate the weighted ratings/scores of the sub-attributes, the steps of assigning weights and generating weighted ratings/score for the attributes and/or data handling approaches may be optional.

Responsive to generating the rating/score for the vehicle 102, in operation 416, the privacy rating/score for the vehicle 102 is transmitted to the user computing device 108 for presentation to the user 106. In addition to presenting the rating/score of the vehicle 102 to the user 106, the client application 314a of the user computing device 108a may provide an interactive user interface that allows the user 106 to drill down and view the rating/score associated with each data handling approach, and each attribute or sub-attribute thereof. Further, in some examples, the client application 314a may operate in concert with the server 112a to present, inter alia, other vehicles having similar or a higher privacy rating/score.

In operations 420-426, the client application 314a of the user computing device 108a may be configured to dynamically adjust the rating/score of the vehicle based on various privacy change factors such as, but not limited to, usage status of the various in-vehicle units, data handling practices of the entities associated with the vehicle and/or the in-vehicle units that handle the data of the user, etc. In one example, in operation 420, the client application 314a may be configured to present a user interface that prompts a user 106 to provide information on any changes to the usage status of the various in-vehicle units 104 of the vehicle 102. For example, the user 106 may be presented with a screen that requests the user to identify any new in-vehicle units 104 that have been added or activated, or any in-vehicle units that have been deactivated. If any new in-vehicle units have been added and/or activated, the user 106 may be prompted to provide information regarding the new in-vehicle unit 104. Responsive to receiving an input from the user 106, in operation 422, information regarding the new in-vehicle unit 104 may be transmitted to the server 112a. Further, in operation 422, a rating adjustment module 234 of privacy server 112a may dynamically adjust the rating/score of the vehicle 102 based on the data handling approaches associated with the new in-vehicle unit 104. It is noted that operations 408-414 may be followed to adjust the rating/score (or generate the new privacy rating/score) of the vehicle 102. Similarly, if any existing in-vehicle units have been deactivated, the server 112a may be configured to adjust the rating/score of the vehicle 102.

Alternatively or in addition to requesting information regarding changes to the usage status of in-vehicle units 104, in operation 420, the client application 314a may be configured to receive feedback from a user 106 regarding whether the rating/score for the vehicle 102 meets the rating/score threshold of the user 106. Responsive to determining that the current rating/score for the vehicle 102 does not meet the rating/score threshold of the user 106, the client application 314a may be configured to provide the user 106 with an option to adjust the rating/score for the vehicle 102.

In particular, the client application 314a may be configured to operate in concert with the server 112a to generate recommendations/suggestions (interchangeable referred to as “actions”) that may help to increase the rating/score of the vehicle 102. For example, the client application 314a may suggest the user 106 to: de-activate some of the in-vehicle units 104 that have poor data handling approaches in general; send requests to an entity that handles the data of the user to stop handling the data of the user 106; file a data security or privacy breach complaint; use a different dealership or rental agency; change the model, trim, and year of the vehicle; switch an in-vehicle unit with a similar in-vehicle unit from a different entity having better data handling approaches; etc. It is noted that the example suggestions listed above are non-limiting, and other appropriate suggestions may be provided without departing from a broader scope of the present disclosure. In some embodiments, the client application 314a and the server 112a may operate in concert to provide an explanation or a list of factors that may be affecting the rating/score of the vehicle 102.

In operation 420, responsive to determining that the usage status of the various in-vehicle units 104 has not changed, the rating generation process 400 proceeds to operation 424. In operation 424, the client application 314a may be configured to determine whether a request has been received from a user 106 associated with the vehicle 102 and/or the in-vehicle units 104 regarding a desired change in control of the user's data by the entities associated with the vehicle 102 and/or the in-vehicle units 104. In particular, in operation 424, the client application 314a may be configured to generate a user interface that provides an option for the user 106 to place requests to one or more entities (associated with the vehicle 102 and/or in-vehicle units 104) that handle the data of the user to change how the user's data is handled. If the user 106 places (i.e., initiates or inputs) a request, the user computing device 108a may transmit the request to the server 112a. Further, in operation 424, a compliance module 232a may generate and transmit a formal request with the concerned entities on behalf of the user 106 and based on the request received from the user 106. In other words, the rating system operates as a mediation platform between the user 106 and the entities associated with the vehicle 102 and/or in-vehicle units 104 that handle the personal data of the user 106.

Responsive to transmitting the formal request on behalf of the user 106, in operation 426, the compliance module 232a may initiate a timer to determine whether the concerned entities respond to the formal request within a given timeframe. If the concerned entities respond to formal request within the given timeframe, the privacy compliance module 232a may operate in concert with a rating adjustment module 234a to adjust the rating/score of the vehicle based on the response. If the concerned entities respond to formal request within the given timeframe, an extension may be provided for responding. If the concerned entities do not respond to formal request within the extended timeframe, the compliance module 232a may operate in concert with the rating adjustment module 234a to dynamically adjust the rating/score of the vehicle based on the lack of response. Further, the compliance module 232a may generate and file a complaint with appropriate regulating bodies and/or other concerned authorities.

In some examples, the response from the concerned entities may be analyzed and rated/scored using natural language processing and machine learning models (or alternatively using non-artificial intelligence based methods). The rating/score may be adjusted based on the rating/score associated with the response from the concerned authorities.

For example, the user 106 may request Ford Motors to stop collecting and/or storing the user's data via the privacy client application 314a. Responsively, the user computing device 108a may transmit the request to the server 112a which in turn generates and transmits a formal request to Ford Motors on behalf of the user 106. Further, the server 112a may provide 30 days and an extension of an additional 30 days to Ford Motors for responding to the request. Based on the response or lack of response from Ford Motors, the rating/score associated with the Ford Explorer associated with the user 106 may be adjusted. If Ford Motors complies with the request, the rating/score may be increased, and the compliance may further affect the rating/score for other Ford vehicles as well. If Ford Motors complies with and responds to a threshold number of requests from the user, the rating/score of the data handling approaches of Ford Motors may be increased in general.

In operation 424, if the client application 314a determines that no request has been received from the user 106 with regards to a change in control of the data of the user 106, the rating generation process 400 of the rating system 100 may end in operation 430.

It is noted that the change factors described above are examples and are non-limiting. In other words, the rating generation process 400 may be configured to adjust the rating/score of the vehicle based on fewer or more change factors without departing from a broader scope of the present disclosure. For example, it should be appreciated that data handling approaches may change over time, and that such changes may be relevant to the rating/score of the vehicle. The server 112a may be configured to detect a change to a previously scored data handling approach and, in response to detecting the change, the privacy server 112a may be configured to dynamically adjust the rating/score of the vehicle (e.g., in real-time based on any of the privacy change factors). In some embodiments, the server 112a may retrieve the data handling approach from the website via the Internet bot or said data handling approach may be sent to the server 112a by the appropriate source 114. The server 112a may be configured to review the data handling approaches periodically. Responsive to obtaining the data handling approach, the server 112a may verify the data handling approach against the stored data handling approach to detect any changes, and may return the privacy rating/score to the user computing device 108 when no changes are detected. If a change is detected, the server 112a may analyze the change, determine an adjusted rating/score, and send the adjusted rating/score to the user computing device 108 along with an indication of the change for presentation to the user 102.

It is noted that even though the present disclosure describes a system for generating rating/scores for vehicle, one of skill in the art can understand and appreciate that the system of the present disclosure can also be used to generate ratings/score for other complex systems such as, but not limited to, Internet of Things (IoT) devices.

For the avoidance of doubt the server 112b may function in a manner substantially analogous to the server 112a, and may therefore include: a network interface 202b, a memory 204b, a processor 206b, a machine learning model database 208b, a training dataset 212b, a user preference database 214b, a data retrieval and processing engine 250b, a text preparation module 218b, a training module 220b, a model generation module 22b, a model application model 224b, a vehicle identification module 226b, a vehicle unit determination module 228b, a rating module 230b, a user data control mediation engine 270b, and rating adjustment model 234b; redundant explanation of which is omitted here for clarity. As described above, notwithstanding the foregoing similarities, the server 112b may implement certain privacy-focused modules, databases and engines (e.g., a privacy data retrieval module 216b, a privacy rating engine 260b, a privacy compliance module 232b, and a privacy policy database 210b), whereas the server 112 may more broadly implement various security-and/or privacy-focused and/or synergistic module, databases and engines (e.g., a data handling retrieval module 216a, a rating engine 260a, a compliance module 232a, and a data handling database 210a).

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or in Digital Signal Processor (DSP) circuitry).

The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
generating, using artificial intelligence algorithms and a training dataset, at least one machine learning model that is configured to generate scores for multiple attributes of one or more data handling approaches associated with a vehicle and/or an in-vehicle unit of the vehicle that handles data of a user,
wherein the training dataset comprises a plurality of labelled documents that define the one or more data handling approaches associated with the vehicles and/or the in-vehicle unit, and wherein each labelled document has scores pre-assigned to one or more of the multiple attributes of the respective data handling approach associated therewith;
receiving identification information;
determining one or more data handling approaches of a target vehicle and/or a target in-vehicle unit, in either case, which are associated with the identification information and that handles data of the user;
analyzing the one or more data handling approaches associated with the target vehicle or the target in-vehicle unit;
generating, using the at least one machine learning model and the one or more data handling approaches that have been analyzed, scores for the multiple attributes of each of the one or more data handling approaches; and
processing the scores to generate a data handling score for one or both of the target vehicle or in-vehicle unit.

2. The method of claim 1, wherein the data handling score comprises a security score for one or both of the target vehicle or the in-vehicle unit.

3. The method of claim 2, wherein the security score comprises an indication of whether the data of the user is viewed or accessed by authorized individuals.

4. The method of claim 1, wherein the determining of the one or more data handling approaches further comprises
identifying digital web content associated with the target vehicle or the target in-vehicle unit, wherein the digital web content comprises at least one of, with respect to the target vehicle or the target in-vehicle unit, data handling practices, known vulnerabilities, or online news;
analyzing the digital web content to determine one or more data handling attributes associated with the digital web content; and
determining the data handling approach based on the determined one or more data handling attributes of the analyzed web content.

5. The method of claim 4, further comprising identifying digital web content using one or both of a third-party database or a web crawler.

6. The method of claim 4, wherein the identifying of the digital web content further comprises identifying the digital web content by scraping open APIs.

7. The method of claim 4, wherein
the digital content comprises data handling practices associated with either the target vehicle or the target in-vehicle unit, and
the method further comprises
analyzing a content of said data handling practices to determine a plurality of practice topics and associated provisions,
comparing said determined provisions to one or more baseline provisions associated with a respective practice topics,
determining said one or more data handling attributes based on an indication of a deviation of said compared provisions from said one or more baseline provisions, and
updating the data handling approach based on said indication.

8. The method of claim 7, wherein the data handling practices comprise one or more practice topics associated with, in each case for the respective targe vehicle or the target in-vehicle unit, an encryption topic, a data retention topic, an authentication topic, a known transmission protocol topic, an API topic, or a software bill of materials topic.

9. The method of claim 7, wherein
the digital web content comprises known vulnerabilities, and
the method further comprises
identifying a software bill of materials,
comparing the known vulnerabilities to the software bill of materials,
determining said one or more data handling attributes based on an indication of a presence of said known vulnerability in the software bill of materials, and
updating the data handling approach indicative of software vulnerabilities of contained within software bill of materials.

10. The method of claim 9, wherein the known vulnerabilities comprise published bugs or security holes in open source software components.

11. The method of claim 9, wherein the known vulnerabilities are extracted from KEV Catalog or CVE Notices.

12. The method of claim 4, wherein
the digital content comprises online news associated with the respective target vehicle or the target in-vehicle unit, wherein the online news comprises at least one of online business news, social media news, or dark web news, and
the method further comprises, for each such digital content,
analyzing a content of said online news to determine a plurality of topical entries and associated topical data,
comparing said determined topical data to one or more baseline conditions associated with a respective topical entry,
determining said one or more data handling attributes based on an indication of a deviation of said determined topical data from said one or more baseline conditions, and
updating the data handling approach based on said indication.

13. The method of claim 12, wherein the topical entries comprise a breach notification, a regulatory action, a white-hat disclosure, a black-hat announcement, an indication of data for sale, an indication of hacks for sale.

14. The method of claim 13, wherein
the online news comprises at least two of the online business news, social media news, or dark web news,
the method further comprises determining a relative reliability of the at least two of the online business news, social media news, or dark web news, and
the updating of the data handling approach indicative of deviations in the online news further comprises influencing the data handling approach to a greater extent based on the online news having a greater relative reliability as compared to the online news having a lesser relative reliability.

15. The method of claim 4, further comprising creating or supplementing the plurality of labelled documents for the generating of the at least one machine learning model by storing labelled documents indicative of the determined data handling approach.

16. A method comprising:
generating, using artificial intelligence algorithms and a training dataset, at least one machine learning model that is configured to generate a data handling score associated with a vehicle and/or an in-vehicle unit of the vehicle that handles data of a user,
wherein the training dataset comprises a plurality of labelled documents that define one or more data handling approaches associated with the vehicles and/or the in-vehicle unit, and wherein each labelled document has scores pre-assigned to the respective data handling approach associated therewith;
receiving identification information;
determining one or more data handling approaches of a target vehicle and/or a target in-vehicle unit, in either case, which are associated with the identification information and that handles data of the user, wherein the determining comprises, identifying digital web content associated with the target vehicle or the target in-vehicle unit, wherein the digital web content comprises at least one of, with respect to the target vehicle or the target in-vehicle unit, data handling practices, known vulnerabilities, or online news;
analyzing the one or more data handling approaches associated with the target vehicle and the at least one in-vehicle unit of the target vehicle;
generating, using the at least one machine learning model and the one or more data handling approaches that have been analyzed, a data handling score for the target vehicle or the target in-vehicle unit; and
dynamically adjusting the data handling score for one or both of the target vehicle or the in-vehicle unit based on data handling change factors.

17. The method of claim 16, wherein the artificial intelligence algorithms comprise natural language processing algorithms and machine learning algorithms.

18. The method of claim 16, wherein the one or more data handling approaches are analyzed using natural language processing algorithms that are configured to generate feature vectors from the one or more data handling approaches.

19. The method of claim 16, wherein the data handling change factors comprise at least one of a usage status of the target in-vehicle unit or data handling practices of entities associated with the target vehicle and/or the target in-vehicle unit that handle the data of the user.

20. A method comprising:
generating, using artificial intelligence algorithms and a training dataset, at least one machine learning model that is configured to generate scores for multiple attributes of one or more data handling approaches associated with a vehicle and/or a service provider associated with the vehicle that handles data of a user,
wherein the training dataset comprises a plurality of labelled documents that define the one or more data handling approaches associated with the vehicles and/or the service provider, and wherein each labelled document has scores pre-assigned to one or more of the multiple attributes of the respective data handling approach associated therewith;
receiving identification information;
determining one or more data handling approaches associated with a target vehicle linked to the identification information and at least one service provider of the target vehicle that handles data of the user, wherein the one or more data handling approaches is based, at least in part, on, with respect to the target vehicle and/or the service provider of the target vehicle, data handling policies, known vulnerabilities, or online news;
analyzing the one or more data handling approaches associated with the target vehicle and/or the at least one service provider of the target vehicle;
generating, using the at least one machine learning model and the one or more data handling approaches that have been analyzed, scores for the multiple attributes of each of the one or more data handling approaches;
processing the scores to generate a data handling score one or both of the target vehicle or the service provider of the target vehicle.
